(19) United States
(12) Patent Application Publication
(10) Pub. No.: US 2025/0308454 A1
(43) Pub. Date: Oct. 2, 2025

(54) DISPLAY DEVICE AND ELECTRONIC APPARATUS

(71) Applicant: SEIKO EPSON CORPORATION, Tokyo (JP)

(72) Inventors: Tsuyoshi TAMURA, HARA-MURA (JP); Hitoshi OTA, SHIOJIRI-SHI (JP); Robina ATSUCHI, CHINO-SHI (JP); Takehiko KUBOTA, MATSUMOTO-SHI (JP)

(73) Assignee: SEIKO EPSON CORPORATION, Tokyo (JP)

(21) Appl. No.: 19/091,746

(22) Filed: Mar. 26, 2025

(30) Foreign Application Priority Data
Mar. 27, 2024 (JP) 2024-051309

(51) Int. Cl. G09G 3/3233

(52) U.S. Cl. CPC G09G 3/3233; G09G 2300/0426; G09G 2300/0452; G09G 2300/0804; G09G 2300/0819; G09G 2300/0852; G09G 2310/061; G09G 2310/08; G09G 2320/0233; G09G 2320/0242; G09G 2320/0666; G09G 2360/16

(57) ABSTRACT

A display device includes first light emitting elements, second light emitting elements, a first data transfer line, a second data transfer line, a first data line, a second data line, first pixel circuits coupled to the first data line, second pixel circuits coupled to the second data line, a first switching circuit controlling electrical coupling between the first data line and the second data transfer line, and a second switching circuit controlling electrical coupling between the second data line and the second data transfer line, the first data line is supplied, from the second data transfer line via the first switching circuit, with a signal for causing each of the plurality of first light emitting elements to emit light, and the second data line is supplied, from the second data transfer line via the second switching circuit, with a signal for causing each of the plurality of second light emitting elements to emit light.

The present application is based on, and claims priority from JP Application Serial Number 2024-051309, filed Mar. 27, 2024, the disclosure of which is hereby incorporated by reference herein in its entirety.

### BACKGROUND

### 1. Technical Field

The disclosure relates to a display device and an electronic apparatus.

### 2. Related Art

A display device including a light emitting element such as an organic electroluminescence (EL) element is known. In this display device, a large number of pixel circuits, each having a plurality of transistors used for driving a light emitting element and controlling the timing of light emission, are coupled to one data line.

For example, JP-A-2021-96418 discloses a display device in which a threshold voltage of a driving transistor of a light emitting element is held at one end of a coupling capacitor provided between a data line and a pixel circuit, and then data is written to the pixel circuit from the other end of the coupling capacitor by a change in voltage according to gradation data.

However, in the display device disclosed in JP-A-2021-96418, when the load capacitance of the data line increases due to an increase in the number of pixels and an increase in screen size caused by high definition of displayed images, it becomes difficult to drive the data line at high speed, and a time required to initialize the voltage of the data line and a time required to write data are increased.

### SUMMARY

One aspect of the present disclosure provides a display device including:
a plurality of first light emitting elements;
a plurality of second light emitting elements;
a first data transfer line extending in a first direction;
a second data transfer line coupled to the first data transfer line and extending in a second direction intersecting the first direction;
a first data line extending in the first direction;
a second data line extending in the first direction;
a plurality of first pixel circuits coupled to the first data line and coupled respectively to the plurality of first light emitting elements;
a plurality of second pixel circuits coupled to the second data line and coupled respectively to the plurality of second light emitting elements;
a first switching circuit controlling electrical coupling between the first data line and the second data transfer line; and
a second switching circuit controlling electrical coupling between the second data line and the second data transfer line, wherein
the first data line is supplied, from the second data transfer line via the first switching circuit, with a signal for causing each of the plurality of first light emitting elements to emit light, and
the second data line is supplied, from the second data transfer line via the second switching circuit, with a signal for causing each of the plurality of second light emitting elements to emit light.

An aspect of an electronic apparatus according to the present disclosure includes the aspect of the display device described above.

### BRIEF DESCRIPTION OF THE DRAWINGS

FIG. 1 is a schematic perspective view showing a display device according to the present embodiment.

FIG. 2 is a schematic plan view showing a display panel of the display device.

FIG. 3 is a block diagram showing an electrical configuration of the display device according to the present embodiment.

FIG. 4 is a diagram showing configurations of a pixel circuit and a data potential generating circuit.

FIG. 5 is a timing chart showing an example of waveforms of various signals in the display device.

FIG. 6 is a diagram showing an operation of the display device.

FIG. 7 is a diagram showing an operation of the display device.

FIG. 8 is a diagram showing an operation of the display device.

FIG. 9 is a diagram showing an operation of the display device.

FIG. 10 is a diagram showing an operation of the display device.

FIG. 11 is a diagram showing an operation of the display device.

FIG. 12 is a diagram showing an operation of the display device.

FIG. 13 is a diagram showing an operation of the display device.

FIG. 14 is a schematic cross-sectional view showing a part of a display panel.

FIG. 15 is a diagram showing a configuration example of the layout of pixel circuits of the display panel.

FIG. 16 is a diagram showing a part of the layout of the display panel.

FIG. 17 is a diagram showing a part of the layout of the display panel.

FIG. 18 is a diagram showing a part of the layout of the display panel.

FIG. 19 is a diagram showing a part of the layout of the display panel.

FIG. 20 is a schematic perspective view showing a head mounted display according to the present embodiment.

FIG. 21 is a diagram showing an image forming device and a light guiding device of the head mounted display according to the present embodiment.

### DESCRIPTION OF EMBODIMENTS

A preferred embodiment of the present disclosure will be described in detail below with reference to the drawings. The embodiment to be described below does not unduly limit the content of the present disclosure described in the claims. In addition, not all configurations to be described below are essential constituent elements of the present disclosure.

### 1. Display Device

### 1-1. Overall Configuration of Display Device

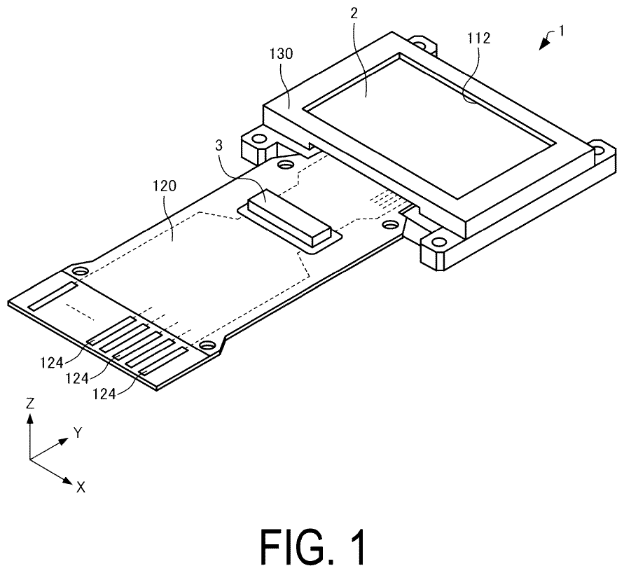

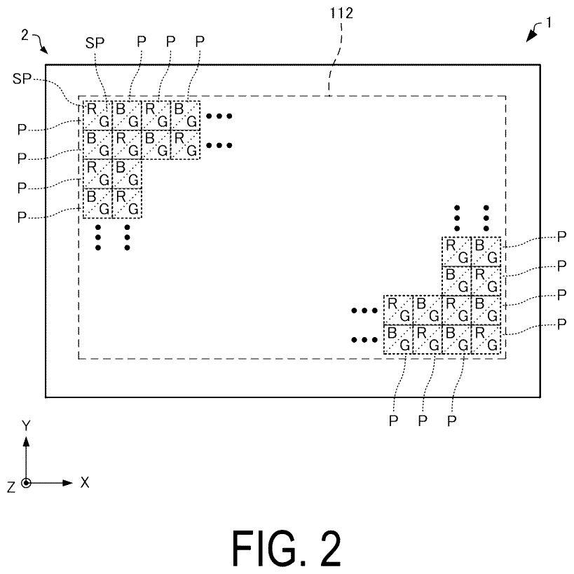

FIG. 1 is a schematic perspective view showing a display device 1 of the present embodiment. FIG. 2 is a schematic plan view showing a display panel 2 of the display device 1 of the present embodiment. FIGS. 1 and 2 show an X-axis, a Y-axis, and a Z-axis as three mutually orthogonal axes.

The display device 1 is, for example, a micro display that displays color images in an HMD. HMD is an abbreviation for Head Mount Display.

As shown in FIG. 1, the display device 1 includes a display panel 2, an FPC board 120, and a case 130. FPC is an abbreviation for Flexible Printed Circuit.

The display panel 2 includes a plurality of light emitting elements, a plurality of pixel circuits respectively coupled to the plurality of light emitting elements, and a driving circuit that drives the pixel circuits. In the present embodiment, the plurality of light emitting elements, the plurality of pixel circuits, and the driving circuit of the display panel 2 are formed at a silicon substrate, and OLEDs are used as the light emitting elements. OLED is an abbreviation for Organic Light emitting Diode.

As shown in FIG. 2, the display panel 2 has a display region 112. In the example shown in the drawing, the display region 112 is a rectangle with long sides parallel to the X-axis. In the display region 112, a plurality of pixels P, which are units of display, are displayed in a matrix at a predetermined arrangement pitch. In the example shown in the drawing, the plurality of pixels P are displayed in a matrix in the X-axis direction and the Y-axis direction. In the following description, it is assumed that m×n pixels P are displayed in m rows in the Y-axis direction and n columns in the X-axis direction. Each of m and n is an integer equal to or greater than 2.

The pixel P has luminance information and may also have color information. When the pixel P has luminance information but has no color information, a black-and-white image is displayed in the display region 112. On the other hand, when the pixel P has luminance information and color information, a color image is displayed in the display region 112. In the following description, it is assumed that the pixel P has luminance information and color information.

Among the m×n pixels P, m×n/2 pixels P are each configured with two subpixels SP, one red and one green, and the remaining m×n/2 pixels P are each configured with two subpixels SP, one blue and one green. The m×n/2 pixels P including red subpixels SP and green subpixels SP and the m×n/2 pixels P including blue subpixels SP and green subpixels SP are displayed in a Pentile array. Specifically, each pixel P in an odd row and an odd column and each pixel P in an even row and an even column includes a red subpixel SP and a green subpixel SP, and each pixel P in an odd row and an even column and each pixel P in an even row and an odd column includes a blue subpixel SP and a green subpixel SP.

As shown in FIG. 1, the display panel 2 is accommodated in and fixed to a frame-shaped case 130 that opens in the display region 112, and one end of the FPC board 120 is coupled thereto. The other end of the FPC board 120 is provided with a plurality of external coupling terminals 124, which are coupled to an external circuit (not shown). A control circuit 3, which is a semiconductor chip, is mounted on the FPC board 120 using COF technology, and image data synchronized with a synchronization signal is supplied from the external circuit via the plurality of external coupling terminals 124, along with the synchronization signal. COF is an abbreviation for Chip On Film. The synchronization signal includes a vertical synchronization signal that instructs the start of vertical scanning of image data, a horizontal synchronization signal that instructs the start of horizontal scanning of image data, and a dot clock signal that indicates the timing of one pixel of image data.

The control circuit 3 supplies various control signals and various potentials generated in accordance with a synchronization signal to the display panel 2, and also supplies data corresponding to each pixel P included in the image data to the display panel 2 in a time-division manner.

### 1-2. Functional Configuration of Display Device

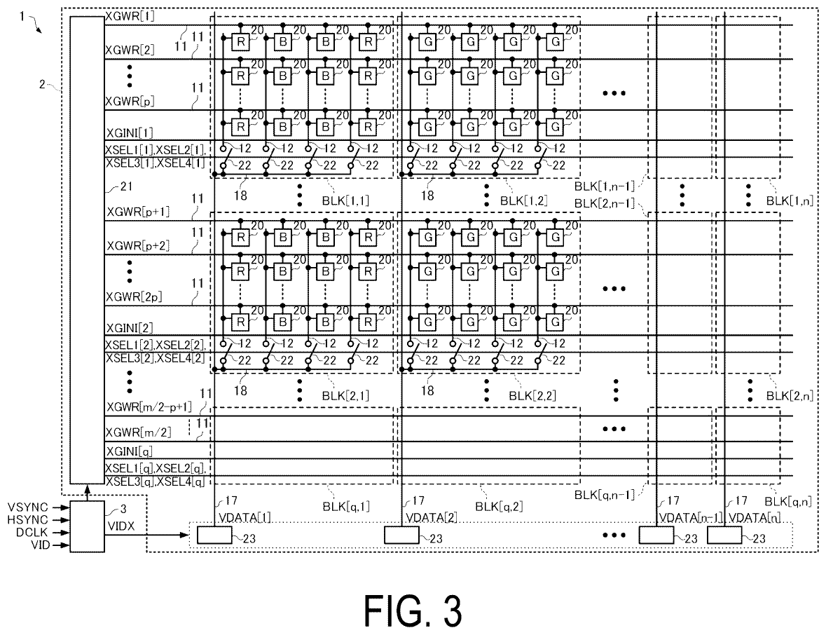

FIG. 3 is a block diagram showing an electrical configuration of the display device 1 according to a first embodiment. As shown in FIG. 3, the display device 1 includes a control circuit 3, a plurality of pixel circuits 20, a scanning line driving circuit 21, a plurality of switching circuits 22, a plurality of data potential generating circuits 23 and a plurality of P-channel MOSFETs 24. The plurality of pixel circuits 20, the scanning line driving circuit 21, the plurality of switching circuits 22, the plurality of data potential generating circuits 23 and the plurality of MOSFETs 24 are provided in the display panel 2. As described above, the control circuit 3 is mounted on the FPC board 120, but may be provided in the display panel 2.

The display panel 2 is provided with m/2 scanning lines 11 arranged in the horizontal direction in the drawing, and is provided with n data transfer lines 17 arranged in the vertical direction in the drawing. In addition, m×n×2 pixel circuits 20 are provided corresponding to the m/2 scanning lines 11 and the n data transfer lines 17. That is, four pixel circuits 20 are provided corresponding to one scanning line 11 and one data transfer line 17, and the m×n×2 pixel circuits 20 are arranged in a matrix of m/2 rows vertically and 4n columns horizontally.

The m×n×2 pixel circuits 20 are divided into q×n pixel circuit blocks BLK[1,1] to BLK[q, n], each including p×4 pixel circuits 20. p and q are integers of 2 or greater that satisfy p×q=m/2. In each pixel circuit block BLK[k, j], the p×4 pixel circuits 20 are coupled in groups of four to p scanning lines 11 in (k−1)×p+1-th to k×p-th rows. k is an integer equal to or greater than 1 and equal to or less than q, and j is an integer equal to or greater than 1 and equal to or less than n. Furthermore, each pixel circuit block BLK[k, j] has four data lines 12 arranged in the vertical direction, and p pixel circuits 20 are coupled to each data line 12.

In each pixel circuit block BLK[k, j] coupled to data transfer lines 17 in odd columns, the p×2 pixel circuits coupled to the first or fourth data line 12 from the left each make p×2 red subpixels SP emit light, and the p×2 pixel circuits coupled to the second or third data line 12 from the left each make p×2 blue subpixels SP emit light. Further, in each pixel circuit block BLK[k, j] coupled to data transfer lines 17 in even columns, the p×4 pixel circuits each make p×4 green subpixels SP emit light. In FIG. 3, pixel circuits 20 that make red subpixels SP emit light are marked with “R”, pixel circuits 20 that make blue subpixels SP emit light are marked with “B”, and pixel circuits 20 that make green subpixels SP emit light are marked with “G”.

In addition, each pixel circuit block BLK[k, j] includes four switching circuits 22, and each of the four switching circuits 22 controls the electrical coupling between each of the four data lines 12 and a data transfer line 18 that branches off from the data transfer line 17 in the horizontal direction under the control of the control circuit 3. That is, when each switching circuit 22 is turned on, each data line 12 is electrically coupled to the data transfer lines 17 and 18, and when each switching circuit 22 is turned off, each data line 12 is electrically decoupled from the data transfer lines 17 and 18.

The control circuit 3 controls each part based on image data VID, a vertical synchronization signal VSYNC, a horizontal synchronization signal HSYNC, and a dot clock signal DCLK which are supplied from an external circuit. The image data VID is data that designates the gradation level of each pixel P of an image to be displayed in the display region 112 for each RGB. That is, the image data VID is data in which the luminance information and color information of each pixel P change every cycle of the dot clock signal DCLK.

Here, since the brightness characteristics indicated by the gradation level do not match the luminance characteristics of the light emitting element, the control circuit 3 converts the image data VID designating the gradation level of the pixel P into image data VIDX designating the luminance corresponding to the gradation level. For example, the control circuit 3 converts 8 bits of R data and G data or 8 bits of B data and G data of each pixel P included in the image data VID into 10 bits of R data and G data or 10 bits of B data and G data designating the luminance of the corresponding light emitting element, thereby generating image data VIDX. For such up-conversion, a lookup table in which correspondence between each of the 8 bits of R data, G data, and B data and each of the 10 bits of R data, G data, and B data is stored in advance is used.

The scanning line driving circuit 21 is a circuit for driving the pixel circuits 20 arranged in m/2 rows and 4n columns, row by row, under control of the control circuit 3, and outputs various signals. For example, the scanning line driving circuit 21 supplies scanning signals XGWR[1] to XGWR[m/2] to the scanning lines 11 in the first to m/2-th row in order. That is, the scanning signal XGWR[i] is supplied to the scanning line 11 in the i-th row.

One data potential generating circuit 23 is provided for each data transfer line 17. That is, the display panel 2 includes n data potential generating circuits 23. The j-th data potential generating circuit 23 from the left generates a data potential VDATA[j] to be supplied to the data transfer line 17 in the j-th column, based on the image data VIDX supplied from the control circuit 3, under the control of the control circuit 3.

Specifically, the integer j is set as an odd number, and the j-th data potential generating circuit 23 from the left acquires, at a timing designated by the control circuit 3, R data of each pixel P in a j-th column of an odd-numbered row, B data of each pixel P in a j-th column of an even-numbered row, B data of each pixel P in a j+1-th column of an odd-numbered row, and R data of each pixel P in a j+1-th column of an even-numbered row, which are included in the image data VIDX, performs D/A conversion thereon, and outputs a data potential VDATA[j] to the data transfer line 17 in the j-th column. In each pixel circuit block BLK[k, j], the pixel circuit 20 coupled to the scanning line 11 in the i-th row and the first data line 12 from the left receives R data of a pixel P in a (2i−1)-th row and the j-th column supplied as data potential VDATA[j], and makes the red subpixel SP of the pixel P emit light. Further, the pixel circuit 20 coupled to the scanning line 11 in the i-th row and the second data line 12 from the left receives B data of a pixel P in a 2i-th row and the j-th column supplied as data potential VDATA[j], and makes the blue subpixel SP of the pixel P emit light. Further, the pixel circuit 20 coupled to the scanning line 11 in the i-th row and the third data line 12 from the left receives B data of a pixel P in the (2i−1)-th row and (j+1)-th column supplied as a data potential VDATA[j], and makes the blue subpixel SP of the pixel P emit light. In addition, the pixel circuit 20 coupled to the scanning line 11 in the i-th row and the fourth data line 12 from the left receives R data of a pixel P in a 2i-th row and the (j+1)-th column supplied as a data potential VDATA[j], and makes the red subpixel SP of the pixel P emit light.

In addition, the integer j is set as an odd number, and the j+1-th data potential generating circuit 23 from the left acquires, at a timing designated by the control circuit 3, G data of each pixel P in a j-th column of an odd-numbered row, G data of each pixel P in a j-th column of an even-numbered row, G data of each pixel P in a j+1-th column of an odd-numbered row, and G data of each pixel P in a j+1-th column of an even-numbered row, which are included in the image data VIDX, performs D/A conversion thereon, and outputs a data potential VDATA[j+1] to the data transfer line 17 in a j+1-th column. In each pixel circuit block BLK[k, j+1], the pixel circuit 20 coupled to the scanning line 11 in the i-th row and the first data line 12 from the left receives G data of a pixel P in a (2i−1)th row and the j-th column supplied as a data potential VDATA[j+1], and makes the green subpixel SP of the pixel P emit light. Further, the pixel circuit 20 coupled to the scanning line 11 in the i-th row and the second data line 12 from the left receives G data of a pixel P in a 2i-th row and the j-th column supplied as a data potential VDATA[j+1], and makes the green subpixel SP of the pixel P emit light. Further, the pixel circuit 20 coupled to the scanning line 11 in the i-th row and the third data line 12 from the left receives G data of a pixel P in a (2i−1)-th row and the (j+1)-th column supplied as a data potential VDATA[j+1], and makes the green subpixel SP of the pixel P emit light. In addition, the pixel circuit 20 coupled to the scanning line 11 in the i-th row and the fourth data line 12 from the left receives G data of a pixel P in a 2i-th row and the (j+1)-th column supplied as a data potential VDATA[j+1], and makes the green subpixel SP of the pixel P emit light.

Thus, the 4n pixel circuits 20 coupled to the scanning line 11 in the i-th row make n pixels P in the (2i−1)-th row and n pixels P in the 2i-th row emit light. For example, the pixel circuit 20 coupled to the scanning line 11 in the first row and the first data line 12 from the left in the pixel circuit block BLK[1,1] and the pixel circuit 20 coupled to the scanning line 11 in the first row and the first data line 12 from the left in the pixel circuit block BLK[1,2] are paired to make the red subpixel SP and green subpixel SP included in the pixel P in the first row and the first column emit light. In addition, the pixel circuit 20 coupled to the scanning line 11 in the first row and the second data line 12 from the left in the pixel circuit block BLK[1,1] and the pixel circuit 20 coupled to the scanning line 11 in the first row and the second data line 12 from the left in the pixel circuit block BLK[1,2] are paired to make the blue subpixel SP and the green subpixel SP included in the pixel P in the second row and the first column emit light. In addition, the pixel circuit 20 coupled to the scanning line 11 in the first row and the third data line 12 from the left in the pixel circuit block BLK[1,1] and the pixel circuit 20 coupled to the scanning line 11 in the first row and the third data line 12 from the left in the pixel circuit block BLK[1,2] are paired to make the blue subpixel SP and the green subpixel SP included in the pixel P in the first row and the second column emit light. In addition, the pixel circuit 20 coupled to the scanning line 11 in the first row and the fourth data line 12 from the left in the pixel circuit block BLK[1,1] and the pixel circuit 20 coupled to the scanning line 11 in the first row and the fourth data line 12 from the left in the pixel circuit block BLK[1,2] are paired to make the red subpixel SP and green subpixel SP included in the pixel P in the second row and the second column emit light.

Although the control circuit 3 supplies various control signals and various potentials to the display panel 2, only a portion thereof is shown in FIG. 3.

### 1-3. Configuration of Pixel Circuit and Data Potential Generating Circuit

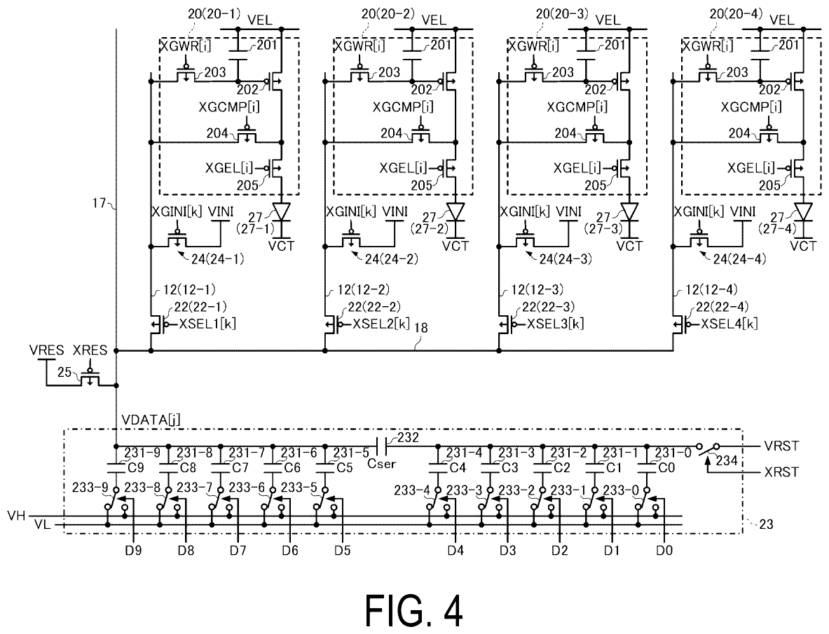

FIG. 4 is a diagram showing a configuration of four pixel circuits 20 included in a pixel circuit block BLK[k, j] and coupled to the scanning line 11 in the i-th row, and the data potential generating circuit 23 that outputs a data potential VDATA[j]. For convenience of description, in FIG. 4, the four pixel circuits 20 are distinguished as pixel circuits 20-1, 20-2, 20-3, and 20-4, respectively, but the four pixel circuits 20 have the same configuration, and the same components are denoted by the same reference numerals. When the integer j is an odd number, the pixel circuit 20-1 is a pixel circuit 20 corresponding to a red subpixel SP of a pixel P in a (2i−1)-th row and the j-th column, the pixel circuit 20-2 is a pixel circuit 20 corresponding to a blue subpixel SP of a pixel P in a 2i-th row and the j-th column, the pixel circuit 20-3 is a pixel circuit 20 corresponding to a blue subpixel SP of a pixel P in a (2i−1)-th row and the (j+1)-th column, and the pixel circuit 20-4 is a pixel circuit 20 corresponding to a red subpixel SP of a pixel P in a 2i-th row and the (j+1)-th column. Furthermore, when the integer j is an even number, the pixel circuit 20-1 is a pixel circuit 20 corresponding to a green subpixel SP of a pixel P in a (2i−1)-th row and the j−1-th column, the pixel circuit 20-2 is a pixel circuit 20 corresponding to a green subpixel SP of a pixel P in a 2i-th row and the j−1-th column, the pixel circuit 20-3 is a pixel circuit 20 corresponding to a green subpixel SP of a pixel P in a (2i−1)-th row and the j-th column, and the pixel circuit 20-4 is a pixel circuit 20 corresponding to a green subpixel SP of a pixel P in a 2i-th row and the j-th column.

Further, in FIG. 4, the four data lines 12 respectively coupled to the pixel circuits 20-1, 20-2, 20-3, and 20-4 are distinguished as data lines 12-1, 12-2, 12-3, and 12-4. Further, in FIG. 4, the four light emitting elements 27 respectively coupled to the pixel circuits 20-1, 20-2, 20-3, and 20-4 are distinguished as light emitting elements 27-1, 27-2, 27-3, and 27-4, but the four light emitting elements 27 have the same configuration. Further, in FIG. 4, four switching circuits 22 coupled to the data transfer line 18 branching off from the data transfer line 17 are distinguished as switching circuits 22-1, 22-2, 22-3, and 22-4, but the four switching circuits 22 have the same configuration. Further, in FIG. 4, four MOSFETS 24 respectively coupled to the data lines 12-1, 12-2, 12-3, and 12-4 are distinguished as MOSFETs 24-1, 24-2, 24-3, and 24-4, but the four MOSFETs 24 have the same configuration.

As shown in FIG. 4, the pixel circuit 20 includes a capacitive element 201 and P-channel MOSFETs 202 to 205 and is coupled to the light emitting element 27. MOSFET is an abbreviation of Metal Oxide Semiconductor Field Effect Transistor.

The light emitting element 27 is an OLED and has a structure in which a light emitting functional layer is sandwiched between a pixel electrode and a common electrode (not shown). The pixel electrode functions as an anode, and the common electrode has light transmittance and functions as a cathode. In the light emitting element 27, when a current flows from the anode to the cathode, holes injected from the anode and electrons injected from the cathode recombine in the light emitting functional layer to generate excitons and generate white light. Then, the generated white light resonates in an optical resonator configured with a reflective layer and a semi-reflective semi-transmissive layer (not shown), and is emitted at a resonant wavelength that is set corresponding to either red, green, or blue. A color filter corresponding to the color is provided on the emission side of the light from the optical resonator. Thus, the light emitted from the light emitting element 27 is colored by the optical resonator and the color filter, and is then visually recognized by an observer. When a black-and-white image is displayed in the display region 112, the color filter is omitted.

A potential VEL is supplied to one end of the capacitive element 201 from the control circuit 3, and the other end of the capacitive element 201 is coupled to a gate of the MOSFET 202 and a drain of MOSFET 203. A potential VEL is supplied to a source of the MOSFET 202, and a drain of the MOSFET 202 is coupled to a drain of the MOSFET 204 and a source of the MOSFET 205. A drain of the MOSFET 205 is coupled to an anode of the light emitting element 27. A potential VCT is supplied to a cathode of the light emitting element 27 from the control circuit 3.

A source of the MOSFET 203 and a source of the MOSFET 204 are coupled to the data line 12. A gate of the MOSFET 203 receives a scanning signal XGWR[i] from the scanning line driving circuit 21. A gate of the MOSFET 204 receives a control signal XGCMP[i] from the scanning line driving circuit 21. A gate of the MOSFET 205 receives a control signal XGEL[i] from the scanning line driving circuit 21.

The MOSFET 202 supplies a current to the light emitting element 27 in accordance with a voltage between its gate and source. Specifically, the higher the voltage between the gate and source of the MOSFET 202, the larger the current flowing through the light emitting element 27, and the greater the amount of light emitted by the light emitting element 27.

The MOSFET 203 controls electrical coupling between the data line 12 and the gate of the MOSFET 202 in accordance with the potential of the scanning line 11. Specifically, when the scanning signal XGWR[i] supplied to the scanning line 11 is at an L level, the MOSFET 203 is turned on to electrically couple the data line 12 and the gate of the MOSFET 202 to each other, and when the scanning signal XGWR[i] is at an H level, the MOSFET 203 is turned off to electrically decouple the data line 12 and the gate of the MOSFET 202 from each other.

The MOSFET 204 controls the electrical coupling between the data line 12 and the drain of the MOSFET 202. Specifically, when the control signal XGCMP[i] is at an L level, the MOSFET 204 is turned on to electrically couple the data line 12 and the drain of the MOSFET 202 to each other, and when the control signal XGCMP[i] is at an H level, the MOSFET 204 is turned off to electrically discouple the data line 12 and the drain of the MOSFET 202 from each other.

The MOSFET 205 controls electrical coupling between the light emitting element 27 and the drain of the MOSFET 202. Specifically, when the control signal XGEL[i] is at an L level, the MOSFET 205 is turned on to electrically couple the anode of light emitting element 27 and the drain of the MOSFET 202 to each other, and when the control signal XGEL[i] is at an H level, the MOSFET 205 is turned off to electrically discouple the anode of light emitting element 27 and the drain of the MOSFET 202 from each other.

As shown in FIG. 4, the pixel circuit block BLK[k, j] includes four MOSFETS 24.

A potential VINI is supplied to a source of the MOSFET 24-1 from the control circuit 3, and a drain of the MOSFET 24-1 is coupled to the data line 12-1 coupled to the pixel circuit 20-1. An input terminal of the switching circuit 22-1 is coupled to the data transfer line 18 branching off from the data transfer line 17, and an output terminal of the switching circuit 22-1 is coupled to the data line 12-1.

Similarly, a potential VINI is supplied to a source of the MOSFET 24-2 from the control circuit 3, and a drain of the MOSFET 24-2 is coupled to the data line 12-2 coupled to the pixel circuit 20-2. An input terminal of the switching circuit 22-2 is coupled to the data transfer line 18, and an output terminal of the switching circuit 22-2 is coupled to the data line 12-2.

Similarly, a potential VINI is supplied to the source of MOSFET 24-3 from the control circuit 3, and a drain of the MOSFET 24-3 is coupled to the data line 12-3 coupled to the pixel circuit 20-3. An input terminal of the switching circuit 22-3 is coupled to the data transfer line 18, and an output terminal of the switching circuit 22-3 is coupled to the data line 12-3.

Similarly, a potential VINI is supplied to a source of the MOSFET 24-4 from the control circuit 3, and a drain of the MOSFET 24-4 is coupled to the data line 12-4 coupled to the pixel circuit 20-4. An input terminal of the switching circuit 22-4 is coupled to the data transfer line 18, and an output terminal of the switching circuit 22-4 is coupled to the data line 12-4.

A control signal XGINI[k] is input to the gates of the MOSFETs 24-1, 24-2, 24-3, and 24-4 from the scanning line driving circuit 21 in response to a control signal from the control circuit 3. In addition, a control signal XSEL1[k] is input to a control terminal of the switching circuit 22-1 from the scanning line driving circuit 21 in response to a control signal from the control circuit 3, a control signal XSEL2[k] is input to a control terminal of the switching circuit 22-2 from the scanning line driving circuit 21 in response to a control signal from the control circuit 3, a control signal XSEL3[k] is input to a control terminal of the switching circuit 22-3 from the scanning line driving circuit 21 in response to a control signal from the control circuit 3, and a control signal XSEL4[k] is input to a control terminal of the switching circuit 22-4 from the scanning line driving circuit 21 in response to a control signal from the control circuit 3.

The MOSFET 24-1 controls the supply of the potential VINI to the data line 12-1. The MOSFET 24-2 controls the supply of the potential VINI to the data line 12-2. The MOSFET 24-3 controls the supply of the potential VINI to the data line 12-3. The MOSFET 24-4 controls the supply of the potential VINI to the data line 12-4. Specifically, when the control signal XGINI[k] is at an L level, the MOSFET 24-1 is turned on to supply the potential VINI to the data line 12-1, the MOSFET 24-2 is turned on to supply the potential VINI to the data line 12-2, the MOSFET 24-3 is turned on to supply the potential VINI to the data line 12-3, and the MOSFET 24-4 is turned on to supply the potential VINI to the data line 12-4. Furthermore, when the control signal XGINI[k] is at an H level, the MOSFET 24-1 is turned off, and no potential VINI is supplied to the data line 12-1. The MOSFET 24-2 is turned off, and no potential VINI is supplied to the data line 12-2. The MOSFET 24-3 is turned off, and no potential VINI is supplied to the data line 12-3. The MOSFET 24-4 is turned off, and no potential VINI is supplied to the data line 12-4.

As shown in FIG. 4, a MOSFET 25 is coupled to the data transfer line 17. A potential VRES is supplied to a source of the MOSFET 25 from the control circuit 3, and a drain of the MOSFET 25 is coupled to the data transfer line 17. A control signal XRES is input to a gate of the MOSFET 25 from the control circuit 3. The MOSFET 25 controls the supply of the potential VRES to the data transfer lines 17 and 18. Specifically, when the control signal XRES is at an L level, the MOSFET 25 is turned on to supply the potential VRES to the data transfer lines 17 and 18, and when the control signal XRES is at an H level, the MOSFET 25 is turned off, and the potential VRES is not supplied to the data transfer lines 17 and 18.

As shown in FIG. 4, the switching circuit 22 is a P-channel MOSFET, but it may also be a transmission gate in which sources and drains of an N-channel MOSFET and a P-channel MOSFET are coupled to each other. In the following, in the switching circuit 22, a gate of a P-channel MOSFET is referred to as a “control terminal”, a source of the P-channel MOSFET is referred to as an “input terminal”, and a drain of the P-channel MOSFET is referred to as an “output terminal”.

The switching circuit 22-1 controls the electrical coupling between the data line 12-1 and the data transfer lines 17 and 18. The switching circuit 22-2 controls the electrical coupling between the data line 12-2 and the data transfer lines 17 and 18. The switching circuit 22-3 controls the electrical coupling between the data line 12-3 and the data transfer lines 17 and 18. The switching circuit 22-4 controls the electrical coupling between the data line 12-4 and the data transfer lines 17 and 18. Specifically, when the control signal XSEL1[k] is at an L level, the switching circuit 22-1 is turned on to electrically couple the data line 12-1 and the data transfer lines 17 and 18 to each other, and when the control signal XSEL1[k] is at an H level, the switching circuit 22-1 is turned off to electrically discouple the data line 12-1 and the data transfer lines 17 and 18 from each other. Furthermore, when the control signal XSEL2[k] is at an L level, the switching circuit 22-2 is turned on to electrically couple the data line 12-2 and the data transfer lines 17 and 18 to each other, and when the control signal XSEL2[k] is at an H level, the switching circuit 22-2 is turned off to electrically discouple the data line 12-2 and the data transfer lines 17 and 18 from each other. When the control signal XSEL3[k] is at an L level, the switching circuit 22-3 is turned on to electrically couple the data line 12-3 and the data transfer lines 17 and 18 to each other, and when the control signal XSEL3[k] is at an H level, the switching circuit 22-3 is turned off to electrically discouple the data line 12-3 and the data transfer lines 17 and 18 from each other. Furthermore, when the control signal XSEL4[k] is at an L level, the switching circuit 22-4 is turned on to electrically couple the data line 12-4 and the data transfer lines 17 and 18 to each other, and when the control signal XSEL4[k] is at an H level, the switching circuit 22-4 is turned off to electrically discouple the data line 12-4 and the data transfer lines 17 and 18 from each other.

Then, when the data line 12-1 and the data transfer lines 17 and 18 are electrically coupled to each other by the switching circuit 22-1, the data potential VDATA[j] is transferred from the data transfer lines 17 and 18 to the data line 12-1. Similarly, when the data line 12-2 and the data transfer lines 17 and 18 are electrically coupled to each other by the switching circuit 22-2, the data potential VDATA[j] is transferred from the data transfer lines 17 and 18 to the data line 12-2. Similarly, when the data line 12-3 and the data transfer lines 17 and 18 are electrically coupled to each other by the switching circuit 22-3, the data potential VDATA[j] is transferred from the data transfer lines 17 and 18 to the data line 12-3. Similarly, when the data line 12-4 and the data transfer lines 17 and 18 are electrically coupled to each other by the switching circuit 22-4, the data potential VDATA[j] is transferred from the data transfer lines 17 and 18 to the data line 12-4.

In reality, in the pixel circuit block BLK[k, j], p pixel circuits 20 are coupled to the data line 12-1, and the p pixel circuits 20 are coupled to p light emitting elements 27, respectively. Then, a signal for causing each of the p light emitting elements 27 to emit light is supplied to the data line 12-1 from the data transfer line 18 via the switching circuit 22-1. Similarly, p pixel circuits 20 are coupled to the data line 12-2, and the p pixel circuits 20 are coupled to p light emitting elements 27, respectively. Then, a signal for causing each of the p light emitting elements 27 to emit light is supplied to the data line 12-2 from the data transfer line 18 via the switching circuit 22-2. Similarly, p pixel circuits 20 are coupled to the data line 12-3, and the p pixel circuits 20 are coupled to p light emitting elements 27, respectively. Then, a signal for causing each of the p light emitting elements 27 to emit light is supplied to the data line 12-3 from the data transfer line 18 via the switching circuit 22-3. Similarly, p pixel circuits 20 are coupled to the data line 12-4, and the p pixel circuits 20 are coupled to p light emitting elements 27, respectively. Then, a signal for causing each of the p light emitting elements 27 to emit light is supplied to the data line 12-4 from the data transfer line 18 via the switching circuit 22-4.

Each MOSFET 25 is coupled to each data transfer line 17, and the control signal XRES is input in common to all of the MOSFETs 25. In addition, four MOSFETs 24 are included in each pixel circuit block BLK[k, j], and the control signal XGINI[k] is input in common to 4n MOSFETs 24 included in n pixel circuit blocks BLK[k, 1] to BLK[k, n]. In addition, the control signal XSEL1[k] is input in common to the switching circuits 22 coupled to the data line 12 in the first column which is included in each of the n pixel circuit blocks BLK[k, 1] to BLK[k, n]. Similarly, the control signal XSEL2[k] is input in common to the switching circuits 22 coupled to the data line 12 in the second column which is included in each of the n pixel circuit blocks BLK[k, 1] to BLK[k, n]. Similarly, the control signal XSEL3[k] is input in common to the switching circuits 22 coupled to the data line 12 in the third column which is included in each of the n pixel circuit blocks BLK[k, 1] to BLK[k, n]. Similarly, the control signal XSEL4[k] is input in common to the switching circuits 22 coupled to the data line 12 in the fourth column which is included in each of the n pixel circuit blocks BLK[k, 1] to BLK[k, n].

As shown in FIG. 4, 10-bit image data VIDX is input to the data potential generating circuit 23 from the control circuit 3. In FIG. 4, the most significant bits of the image data VIDX are denoted as D9, D8, D7, D6, D5, D4, D3, D2, D1, and D0 in this order.

The data potential generating circuit 23 includes a capacitive DAC including capacitive elements 231-0 to 231-9 and 232 and switching circuits 233-0 to 233-9 and 234.

One end of each of the capacitive elements 231-0 to 231-4 and an output terminal of the switching circuit 234 are coupled to one end of the capacitive element 232. One end of each of the capacitive elements 231-5 to 231-9 is coupled to the other end of the capacitive element 232 and the data transfer line 17. The other ends of the capacitive elements 231-0 to 231-9 are coupled to respective output terminals of the switching circuits 233-0 to 233-9. A potential VL is supplied to a first input terminal of each of the switching circuits 233-0 to 233-9 from the control circuit 3, and a potential VH higher than the potential VL is supplied to a second input terminal of each of the switching circuits 233-0 to 233-9 from the control circuit 3. Bits D0 to D9 of the image data VIDX are input to control terminals of the switching circuits 233-0 to 233-9 from the control circuit 3. When a bit Dr is at an L level, electrical conduction is allowed between a first input terminal and output terminal of a switching circuit 233-r, and when the bit Dr is at an H level, electrical conduction is allowed between a second input terminal and output terminal thereof. That is, the switching circuit 233-r outputs the potential VL when the bit Dr is at an L level, and outputs the potential VH when the bit Dr is at an H level. r is an integer equal to or greater than 0 and equal to or less than 9.

When the capacitance value of the capacitive element 231-r is Cr, for example, C0:C1:C2:C3:C4:C5:C6:C7:C8:C9=1:2:4:8:16:1:2:4:8:16. In addition, a capacitance value Cser of the capacitive element 232 may be the same as C0 and C5. A certain degree of error is permissible for the capacitance values C0 to C9 and Cser, as long as linearity is maintained between the value of the input 10-bit image data VIDX and the data potential VDATA[j] to be output.

A potential VRST is supplied to an input terminal of the switching circuit 234 from the control circuit 3, and a control signal XRST is input to a control terminal of the switching circuit 234 from the control circuit 3. When the control signal XRST is at an L level, electrical conduction is allowed between the input terminal and output terminal of the switching circuit 234, and when the control signal XRST is at an H level, electrical conduction is not allowed between the input terminal and output terminal thereof. Thus, when the control signal XRST is at an L level, the potential VRST is supplied to one end of each of the capacitive elements 231-0 to 231-4 and one end of the capacitive element 232. Since one end of each of the capacitive elements 231-5 to 231-9 and the other end of the capacitive element 232 are coupled to the data transfer line 17, the potential VRES is supplied when the control signal XRES is at an L level. For this reason, when the control signal XRST and the control signal XRES are both at an L level, charges stored in the capacitive elements 231-0 to 231-9 and 232 are initialized.

On the other hand, when the control signals XRST and XRES are both at an H level, charges corresponding to the logic level of each of the bits D0 to D9 are stored in each of the capacitive elements 231-0 to 231-9. Since one end of each of the capacitive elements 231-0 to 231-4 is coupled to one end of the capacitive element 232, one end of the capacitive element 232 has a potential corresponding to the logic level of each of the bits D0 to D4. In addition, since one end of each of the capacitive elements 231-5 to 231-9 is coupled to the other end of the capacitive element 232, the other end of the capacitive element 232 has a potential obtained by shifting the potential corresponding to the logic level of each of the bits D5 to D9 in accordance with the potential at one end of the capacitive element 232. Thus, the potential at the other end of the capacitive element 232 changes linearly with respect to the bits D9 to D0, and is supplied to the data transfer line 17 as the data potential VDATA[j].

In this manner, the j-th data potential generating circuit 23 acquires the image data VIDX output from the control circuit 3 at a timing designated by the control circuit 3 and performs D/A conversion under the control of the control circuit 3, and generates a data potential VDATA[j] to be supplied to the data transfer line 17. That is, when the integer j is an odd number, the data potential VDATA[j] switches in a time-division manner at a timing when R data or B data of the corresponding subpixel SP is written to the m/2×4 pixel circuits 20 coupled to the data transfer line 17. In addition, when the integer j is an even number, the data potential VDATA[j] switches in a time-division manner at a timing when G data of the corresponding subpixel SP is written to the m/2×4 pixel circuits 20 coupled to the data transfer line 17.

### 1-4. Operation of Display Device

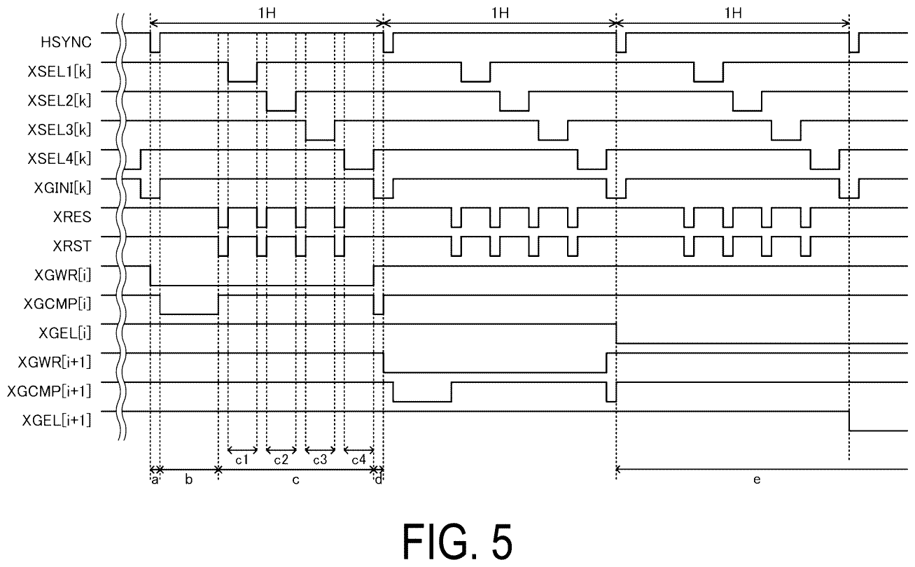

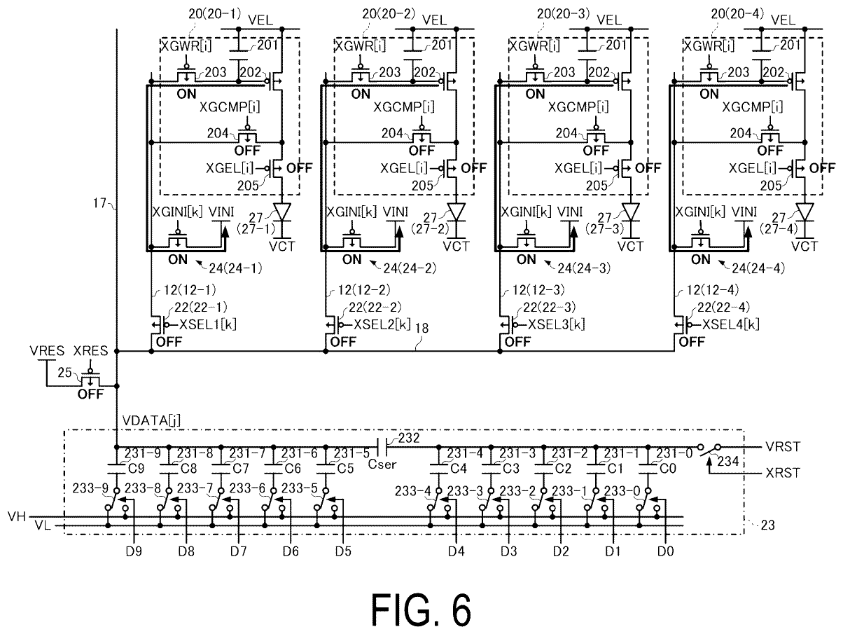

The operation of the display device 1 will be described with reference to FIGS. 5 to 13. FIG. 5 is a timing chart showing an example of waveforms of various signals in the display device 1. FIGS. 6 to 13 are diagrams in which turn-on/turn-off of MOSFETs and switching circuits during each period and supply paths of various potentials are added to FIG. 4.

As shown in FIG. 5, a period of one cycle from the timing when the horizontal synchronization signal HSYNC input from the external circuit of the display device 1 transitions from an H level to an L level to the timing when the horizontal synchronization signal HSYNC next transitions from an H level to an L level is equivalent to a horizontal scanning period 1H. During each horizontal scanning period 1H, data is written to 4n pixel circuits 20 corresponding to 2n pixels P of two rows. During each horizontal scanning period 1H, the scanning line driving circuit 21 outputs the control signals XGEL[i] and XGCMP[i] and the scanning signal XGWR[i] in common to 2n pixel circuits 20 corresponding to n pixels P in the (2i−1)-th row and 2n pixel circuits 20 corresponding to n pixels P in the 2i-th row. The 2n pixel circuits 20 corresponding to the n pixels P in the (2i−1)-th row and the 2n pixel circuits 20 corresponding to the n pixels P in the 2i-th row are 4n pixel circuits 20 coupled to the scanning line 11 in the i-th row. Furthermore, the control circuit 3 outputs the control signal XRES in common to the q×n pixel circuit blocks BLK[1,1] to BLK[q, n], and outputs the control signals XGINI[k], XSEL1[k], XSEL2[k], XSEL3[k], and XSEL4[k] in common to the n pixel circuit blocks BLK[k, 1] to BLK[k, n]. FIG. 5 is a timing chart focusing on the horizontal scanning period 1H in the i-th row after the horizontal scanning period 1H in the first row to the i−1-th row has ended.

As shown in FIG. 5, the horizontal scanning period 1H in the i-th row includes an initialization period a, a compensation period b after the initialization period a, a write period c after the compensation period b, and a data line fixed period d after the write period c. After the data line fixed period d, a light emission period e is formed with a time interval, and after the elapse of a period of one frame, the horizontal scanning period 1H in the i-th row is reached again. The period of one frame corresponds to a period of one cycle of the vertical synchronization signal VSYNC, and is a period required to display one frame of an image designated by the image data VID. For example, when the frequency of the vertical synchronization signal VSYNC is 60 Hz, the period of one frame is approximately 16.7 milliseconds.

As shown in FIG. 5, in the horizontal scanning period 1H in the i-th row, the scanning signal XGWR[i] is at an L level during the initialization period a. Furthermore, the control signals XGEL[i] and XGCMP[i] are at an H level. Furthermore, the control signal XGINI[k] is at an L level, and the control signals XRES and XRST are at an H level. Furthermore, the control signals XSEL1[k], XSEL2[k], XSEL3[k] and XSEL4[k] are at an H level. For this reason, as shown in FIG. 6, during the initialization period a, the MOSFET 203 is turned on and the MOSFETs 204 and 205 are turned off in the pixel circuits 20-1, 20-2, 20-3 and 20-4. Furthermore, the MOSFETs 24-1, 24-2, 24-3 and 24-4 are turned on, the MOSFET 25 is turned off, and the switching circuits 22-1, 22-2, 22-3 and 22-4 are turned off. Thus, the potential VINI is supplied to the data lines 12-1, 12-2, 12-3, and 12-4 via the MOSFETs 24-1, 24-2, 24-3, and 24-4 from the control circuit 3. Then, in the pixel circuits 20-1, 20-2, 20-3, and 20-4, the potential VINI is supplied to the gate of the MOSFET 202 and the other end of the capacitive element 201. That is, the potential of the data line 12, the gate of the MOSFET 202, and the other end of the capacitive element 201 are initialized to the potential VINI.

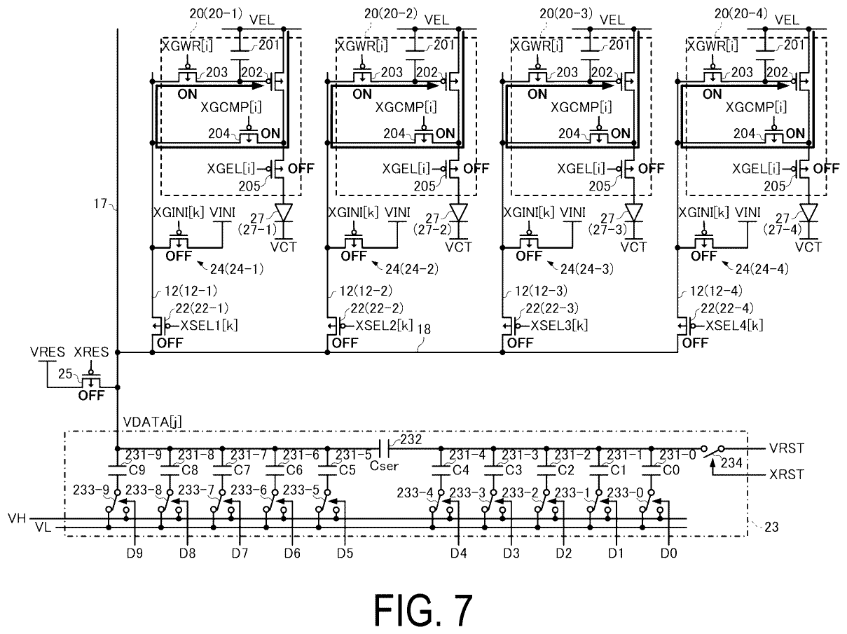

As shown in FIG. 5, in the horizontal scanning period 1H in the i-th row, the scanning signal XGWR[i] is at an L level during the compensation period b. Furthermore, the control signal XGCMP[i] is at an L level, and the control signal XGEL[i] is at an H level. Furthermore, the control signals XGINI[k], XRES, and XRST are at an H level. Furthermore, the control signals XSEL1[k], XSEL2[k], XSEL3[k], and XSEL4[k] are at an H level. For this reason, as shown in FIG. 7, during the compensation period b, the MOSFETs 203 and 204 are turned on and the MOSFET 205 is turned off in the pixel circuits 20-1, 20-2, 20-3, and 20-4. Furthermore, the MOSFETs 24-1, 24-2, 24-3, 24-4, and 25 are turned off, and the switching circuits 22-1, 22-2, 22-3, and 22-4 are turned off. Thus, in the pixel circuits 20-1, 20-2, 20-3, and 20-4, a current flows from the power supply line of the potential VEL to the gate of the MOSFET 202 via the MOSFETs 202, 204, and 203, and the potentials of the data line 12, the gate of MOSFET 202, and the other end of capacitive element 201 rise from the potential VINI. At this time, the MOSFET 202 is in a state where its gate and drain are coupled, that is, in a diode-coupled state, and thus a voltage between the gate and source of the MOSFET 202 converges to a threshold voltage Vth of the MOSFET 202. Since the MOSFET 202 is a P-channel type, the threshold voltage Vth is a negative voltage. Since the potential VEL is supplied to the source of the MOSFET 202, the potential of the data line 12, the gate of the MOSFET 202, and the other end of the capacitive element 201 converge to a potential (VEL−|Vth|).

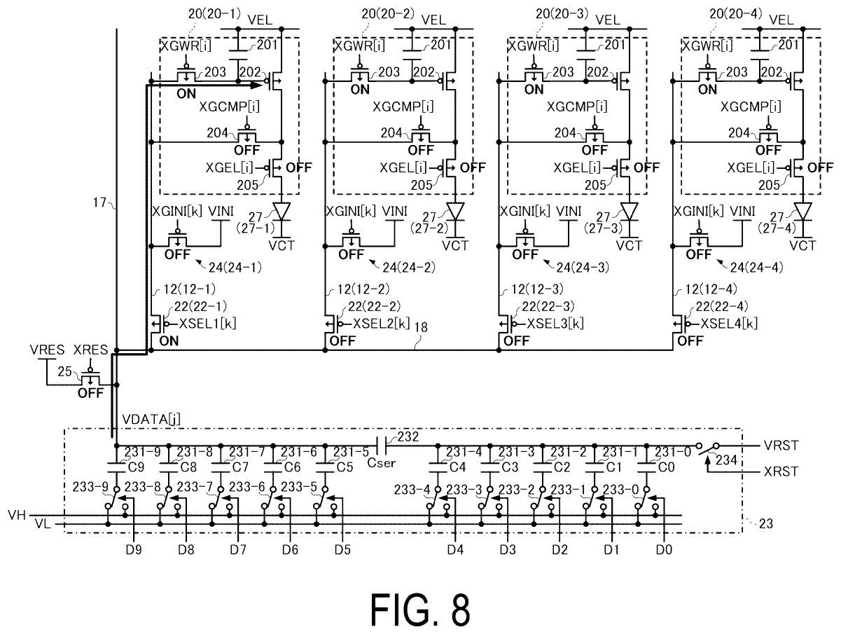

As shown in FIG. 5, in the horizontal scanning period 1H in the i-th row, the scanning signal XGWR[i] is at an L level during the write period c. Furthermore, the control signals XGCMP[i] and XGEL[i] are at an H level. Furthermore, the control signal XGINI[k] is at an H level. For this reason, as shown in FIGS. 8 to 11, during the write period c, the MOSFETs 24-1, 24-2, 24-3, and 24-4 are turned off, and in the pixel circuits 20-1, 20-2, 20-3, and 20-4, the MOSFET 203 is turned on and the MOSFETs 204 and 205 are turned off.

Furthermore, during a first write period c1 included in the write period c, the control signals XRES and XRST are at an H level, the control signal XSEL1[k] is at an L level, and the control signals XSEL2[k], XSEL3[k], and XSEL4[k] are at an H level. For this reason, as shown in FIG. 8, the switching circuit 22-1 is turned on, and the data potential VDATA[j] generated by the data potential generating circuit 23 and output to the data transfer line 17 is transferred from the data transfer line 17 to the data line 12-1 via the switching circuit 22-1. Then, the data potential VDATA[j] transferred to the data line 12-1 is supplied to the other end of the capacitive element 201 and the gate of the MOSFET 202 via the MOSFET 203 in the pixel circuit 20-1.

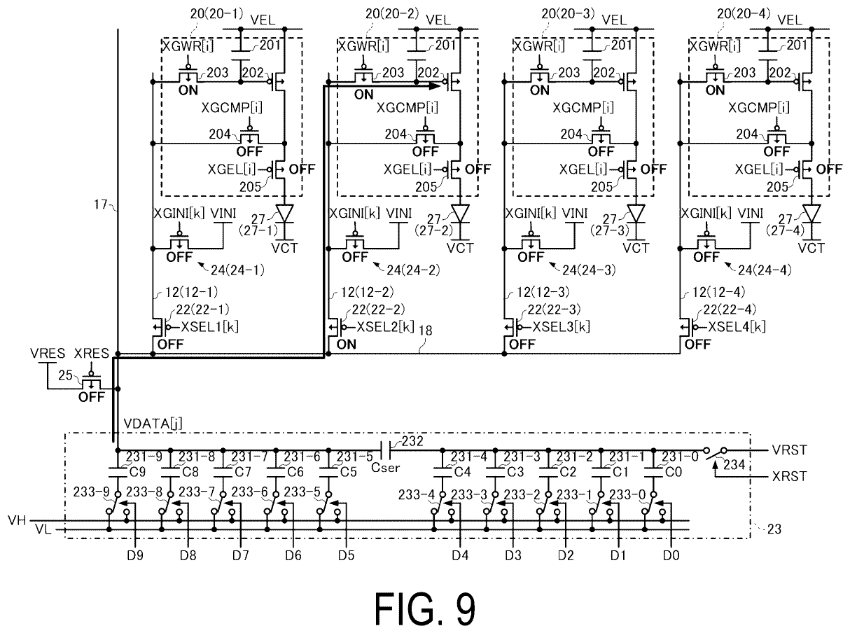

Furthermore, during a second write period c2 included in the write period c, the control signals XRES and XRST are at an H level, the control signal XSEL2[k] is at an L level, and the control signals XSEL1[k], XSEL3[k], and XSEL4[k] are at an H level. For this reason, as shown in FIG. 9, the switching circuit 22-2 is turned on, and the data potential VDATA[j] generated by the data potential generating circuit 23 and output to the data transfer line 17 is transferred from the data transfer line 17 to the data line 12-2 via the switching circuit 22-2. Then, the data potential VDATA[j] transferred to the data line 12-2 is supplied to the other end of the capacitive element 201 and the gate of the MOSFET 202 via the MOSFET 203 in the pixel circuit 20-2.

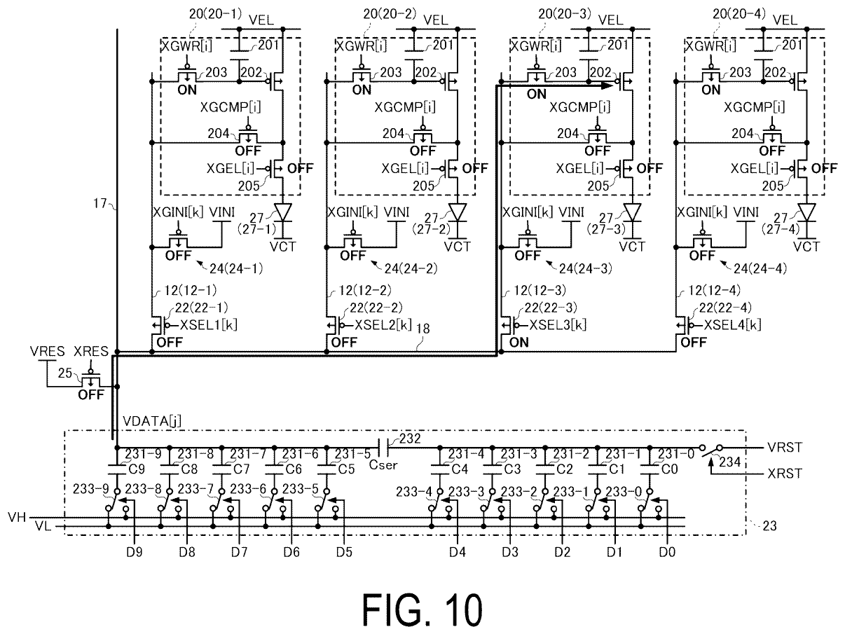

Furthermore, during a third write period c3 included in the write period c, the control signals XRES and XRST are at an H level, the control signal XSEL3[k] is at an L level, and the control signals XSEL1[k], XSEL2[k], and XSEL4[k] are at an H level. For this reason, as shown in FIG. 10, the switching circuit 22-3 is turned on, and the data potential VDATA[j] generated by the data potential generating circuit 23 and output to the data transfer line 17 is transferred from the data transfer line 17 to the data line 12-3 via the switching circuit 22-3. Then, the data potential VDATA[j] transferred to the data line 12-3 is supplied to the other end of the capacitive element 201 and the gate of the MOSFET 202 via the MOSFET 203 in the pixel circuit 20-3.

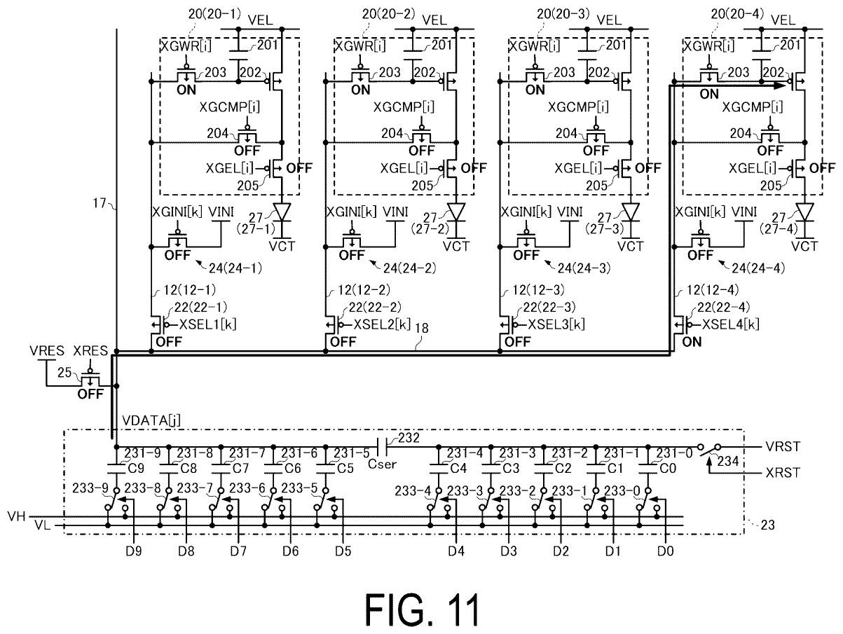

Furthermore, during a fourth write period c4 included in the write period c, the control signals XRES and XRST are at an H level, the control signal XSEL4[k] is at an L level, and the control signals XSEL1[k], XSEL2[k], and XSEL3[k] are at an H level. For this reason, as shown in FIG. 11, the switching circuit 22-4 is turned on, and the data potential VDATA[j] generated by the data potential generating circuit 23 and output to the data transfer line 17 is transferred from the data transfer line 17 to the data line 12-4 via the switching circuit 22-4. Then, the data potential VDATA[j] transferred to the data line 12-4 is supplied to the other end of the capacitive element 201 and the gate of the MOSFET 202 via the MOSFET 203 in the pixel circuit 20-4.

Immediately before each of the first write period c1, the second write period c2, the third write period c3, and the fourth write period c4, the control signals XRES and XRST are set to be at an L level, the MOSFET 25 and the switching circuit 234 are turned on, and charges accumulated in the capacitive elements 231-0 to 231-9 and 232 are initialized.

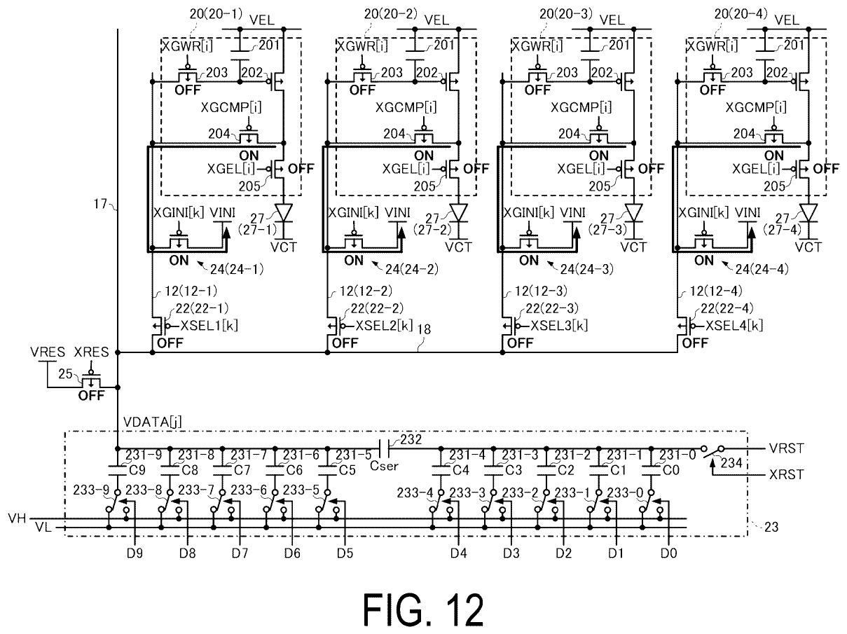

As shown in FIG. 5, in the horizontal scanning period 1H in the i-th row, the scanning signal XGWR[i] is at an H level during the data line fixed period d,. Furthermore, the control signal XGCMP[i] is at an L level, and the control signal XGEL[i] is at an H level. Furthermore, the control signal XGINI[k] is at an L level, and the control signals XRES and XRST are at an H level. Furthermore, the control signals XSEL1[k], XSEL2[k], XSEL3[k], and XSEL4[k] are at an H level. For this reason, as shown in FIG. 12, during the data line fixed period d, the MOSFET 204 is turned on and the MOSFETs 203 and 205 are turned off in the pixel circuits 20-1, 20-2, 20-3, and 20-4. In addition, the MOSFETs 24-1, 24-2, 24-3, and 24-4 are turned on, the MOSFET 25 is turned off, and the switching circuits 22-1, 22-2, 22-3, and 22-4 are turned off. Thus, the potential VINI is supplied from the control circuit 3 to the data lines 12-1, 12-2, 12-3, and 12-4 via the MOSFETs 24-1, 24-2, 24-3, and 24-4. Then, in the pixel circuits 20-1, 20-2, 20-3, and 20-4, the potential VINI is supplied to the drain of the MOSFET 202 and the source of the MOSFET 205. That is, in the pixel circuits 20-1, 20-2, 20-3, and 20-4, the potentials of the drain of the MOSFET 202 and the source of the MOSFET 205 are fixed to the potential VINI.

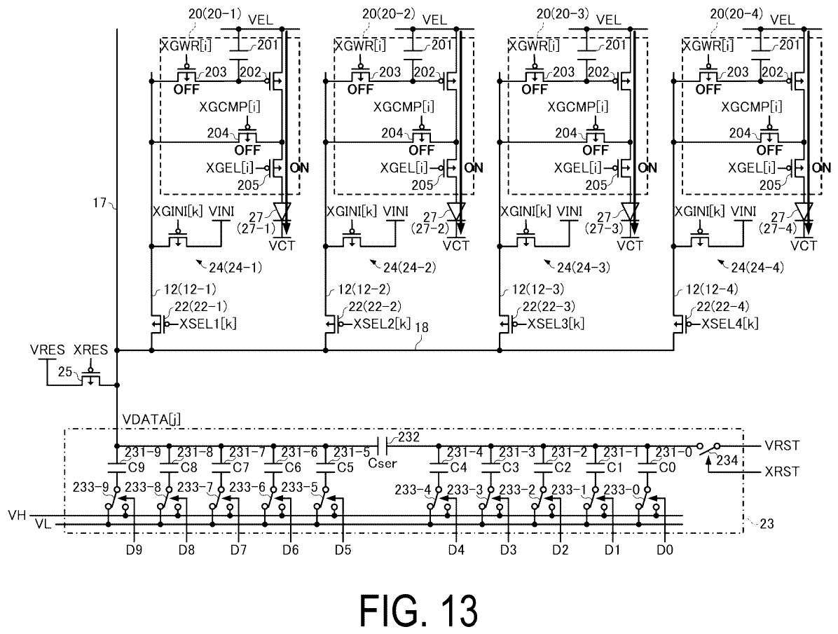

As shown in FIG. 5, in the horizontal scanning period 1H in the i-th row, the scanning signal XGWR[i] is at an H level during the light emission period e. Furthermore, the control signal XGEL[i] is at an L level, and the control signal XGCMP[i] is at an H level. For this reason, as shown in FIG. 13, during the light emission period e, the MOSFET 205 is turned on, and the MOSFETs 203 and 204 are turned off in the pixel circuits 20-1, 20-2, 20-3, and 20-4. Thus, a current flowing from the source to the drain of the MOSFET 202 is supplied to the light emitting element 27 via the MOSFET 205, causing the light emitting element 27 to emit light. In the pixel circuits 20-1, 20-2, 20-3, and 20-4, a current corresponding to the data potential VDATA[j] is supplied to the light emitting element 27 with the threshold voltage Vth of the MOSFET 202 compensated for.

As shown in FIG. 5, in the horizontal scanning period 1H in the i+1-th row following the horizontal scanning period 1H in the i-th row, the control signals XGEL[i+1], and XGCMP[i+1] and the scanning signal XGWR[i+1] become waveforms that are shifted by a time equivalent to the cycle of the horizontal scanning period 1H from the control signals XGEL[i], XGCMP[i] and the scanning signal XGWR[i].

### 1-5. Cross-Sectional Structure of Display Panel

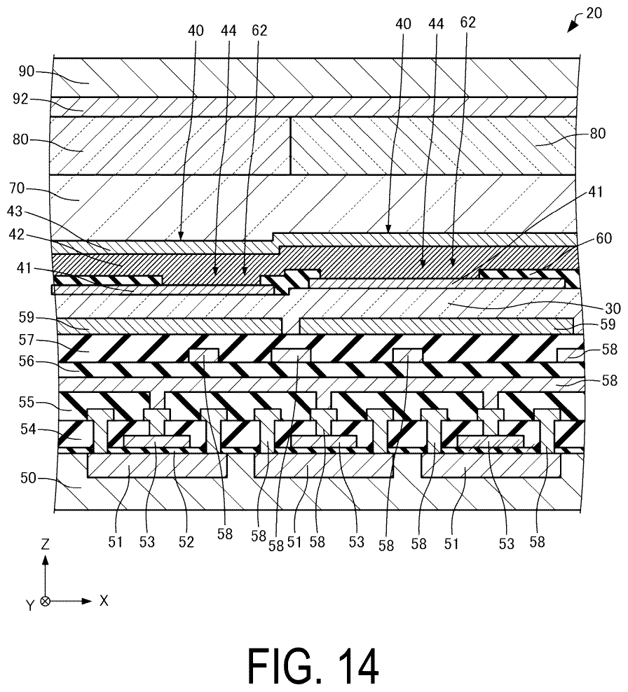

FIG. 14 is a schematic cross-sectional view showing a part of the display panel 2. As shown in FIG. 14, the display panel 2 includes, for example, a substrate 50, interlayer insulating layers 54, 55, 56, and 57, a wiring layer 58, a reflective layer 59, an insulating layer 30, an organic EL element 40, an insulating layer 60, a sealing layer 70, a colored layer 80, and a counter substrate 90.

The substrate 50 is, for example, a silicon substrate. The substrate 50 is provided with an impurity region 51 into which impurities are ion-implanted. The impurity region 51 functions as the sources or drains of the MOSFETs 202 to 205 mentioned above. A gate insulating layer 52 is provided on the substrate 50. The material of the gate insulating layer 52 is, for example, silicon oxide. A gate electrode 53 is provided on the gate insulating layer 52. The material of the gate electrode 53 is, for example, a metal, polysilicon, or the like. The gate electrode 53 functions as the gates of the MOSFETs 202 to 205 mentioned above.

The interlayer insulating layer 54 covers the gate insulating layer 52 and the gate electrode 53. The interlayer insulating layers 54, 55, 56, and 57 are stacked in this order from the substrate 50 side. The interlayer insulating layers 54, 55, 56, and 57 are, for example, silicon oxide layers.

The wiring layer 58 is provided on the interlayer insulating layer 54, the interlayer insulating layer 55, and the interlayer insulating layer 56. The material of the wiring layer 58 is a metal such as aluminum or copper.

The reflective layer 59 is provided on the interlayer insulating layer 57. The reflective layer 59 is provided for each of a plurality of subpixels SP. Two subpixels SP are shown in FIG. 14. The material of the reflective layer 59 is a metal such as aluminum. The reflective layer 59 reflects light, which is generated by the organic EL element 40 and travels toward the substrate 50, toward the colored layer 80.

The insulating layer 30 is provided on the reflective layer 59. The insulating layer 30 has different thicknesses in the red subpixel SP, the green subpixel SP, and the blue subpixel SP. The insulating layer 30 has, for example, a stacked structure in which a plurality of layers are stacked. The insulating layer 30 has different numbers of stacked layers in the red subpixel SP, the green subpixel SP, and the blue subpixel SP. The insulating layer 30 is, for example, a silicon oxide layer, a silicon nitride layer, a silicon oxynitride layer, or the like.

The organic EL element 40 is provided on the insulating layer 30. The organic EL element 40 is, for example, an OLED, and functions as the light emitting element 27 mentioned above. The organic EL element 40 includes a pixel electrode 41, a light emitting functional layer 42, and a common electrode 43.

The pixel electrode 41 is provided on the insulating layer 30. The pixel electrode 41 is provided for each of the plurality of subpixels SP. The pixel electrode 41 transmits light generated by the light emitting functional layer 42. The pixel electrode 41 is a transparent electrode made of, for example, ITO. The pixel electrode 41 is one electrode for injecting a current into the light emitting functional layer 42. ITO is an abbreviation for Indium Tin Oxide.

The light emitting functional layer 42 is provided on the pixel electrode 41. The light emitting functional layer 42 is continuously provided in the plurality of subpixels SP. The light emitting functional layer 42 is configured, for example, by stacking a plurality of light emitting layers. The light emitting functional layer 42 emits, for example, white light.

The common electrode 43 is provided on the light emitting functional layer 42. The common electrode 43 is a common electrode that is continuously provided in the plurality of subpixels SP. The material of the common electrode 43 is, for example, an alloy of magnesium and silver. The common electrode 43 is the other electrode for injecting a current into the light emitting functional layer 42.

The common electrode 43, the insulating layer 30, and the reflective layer 59 form an optically resonant structure. The thickness of the insulating layer 30 is adjusted to form a standing wave of a predetermined wavelength between the reflective layer 59 and the common electrode 43. Thereby, light having a predetermined wavelength can be emitted from the organic EL element 40 for each of the plurality of subpixels SP.

The insulating layer 60 is provided on the pixel electrode 41. The insulating layer 60 is, for example, a silicon oxide layer, a silicon nitride layer, or a silicon oxynitride layer.

An opening 62 is formed in the insulating layer 60. The opening 62 penetrates the insulating layer 60. The insulating layer 60 defines a light emitting region 44 of the organic EL element 40. The light emitting region 44 is a region overlapping the opening 62 of the organic EL element 40 in plan view.

The sealing layer 70 is provided on the common electrode 43. The sealing layer 70 is continuous in the plurality of subpixels SP. The sealing layer 70 is configured, for example, by stacking an inorganic layer and an organic layer. The sealing layer 70 may have a structure in which an organic layer is sandwiched between a pair of inorganic layers. The inorganic layer is, for example, a silicon oxide layer, a silicon nitride layer, or a silicon oxynitride layer. The inorganic layer protects the light emitting functional layer 42 from moisture, oxygen, and the like. The organic layer is, for example, an acrylic-based resin layer. The organic layer improves the flatness of the upper surface of the sealing layer 70.

The colored layer 80 is provided on the sealing layer 70. The colored layer 80 is a color filter configured to transmit light of a predetermined wavelength in each of the red subpixel SP, the green subpixel SP, and the blue subpixel SP. The material of the colored layer 80 is, for example, a color resist.

The counter substrate 90 is provided on the colored layer 80. In the example shown in the drawing, the counter substrate 90 is bonded to the colored layer 80 by an adhesive layer 92. The counter substrate 90 and the adhesive layer 92 transmit light emitted from the colored layer 80. The counter substrate 90 functions as a protective substrate that protects the organic EL element 40 and the colored layer 80.

The display panel 2 is manufactured using, for example, a known semiconductor manufacturing process.

### 1-6. Layout of Display Panel

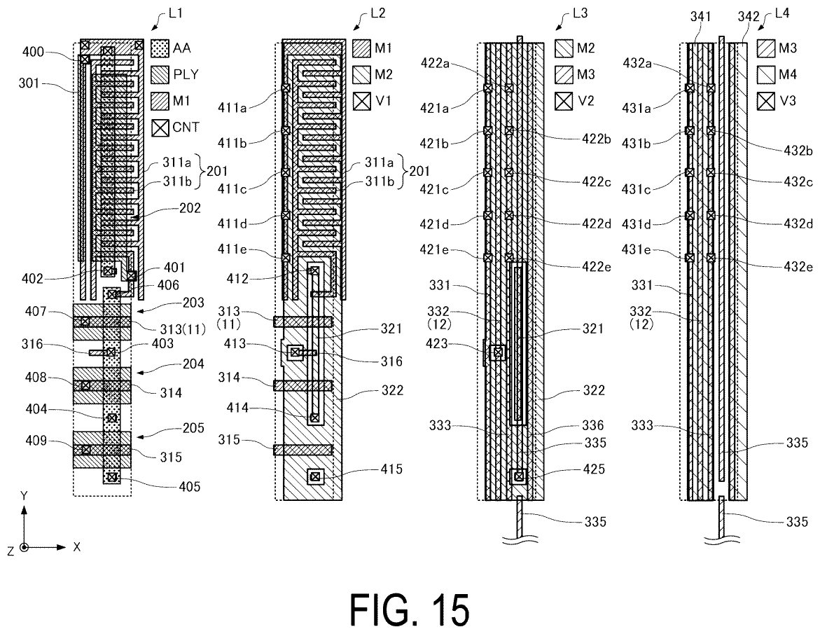

FIG. 15 is a diagram showing a configuration example of the layout of the pixel circuits 20. In FIG. 15, L1 shows the layout of a diffusion layer (AA), a polysilicon layer (PLY), a first wiring layer (M1), and a contact layer (CNT).
Furthermore, L2 shows the layout of a first wiring layer (M1), a second wiring layer (M2), and a first via layer (V1).
Furthermore, L3 shows the layout of a second wiring layer (M2), a third wiring layer (M3), and a second via layer (V2).
Furthermore, L4 shows the layout of a third wiring layer (M3), a fourth wiring layer (M4), a fifth wiring layer (M5), a third via layer (V3), and a fourth via layer (V4).

In FIG. 15, as shown in L1, the MOSFETs 202, 203, 204, and 205 are formed in the diffusion layer and the polysilicon layer. In addition, the capacitive element 201 is formed by two comb-shaped opposing wirings 311a and 311b formed in the first wiring layer.

In FIG. 15, as shown in L1, the gate of the MOSFET 202 formed in the polysilicon layer is coupled to the wiring 311b formed in the first wiring layer by a contact 401. In addition, as shown in L1 and L2, the drain of the MOSFET 202 formed in the diffusion layer is coupled to a wiring 321 formed in the second wiring layer by a contact 402 formed in the contact layer and a via 412 formed in the first via layer. The wiring 321 is coupled to the drain of the MOSFET 204 and the source of the MOSFET 205, which are formed in the diffusion layer, by a via 414 formed in the first via layer and a contact 404 formed in the contact layer.

In FIG. 15, as shown in L1, the gate of the MOSFET 203 formed in the polysilicon layer is coupled to a wiring 313 formed in the first wiring layer by a contact 407. In addition, the source of the MOSFET 203 formed in the diffusion layer is coupled to the wiring 311b by a contact 406. In addition, the gate of the MOSFET 204 formed in the polysilicon layer is coupled to a wiring 314 formed in the first wiring layer by a contact 408. As shown in L1 to L3, the drain of the MOSFET 203 and the source of the MOSFET 204 formed in the diffusion layer are coupled to a wiring 316, which is formed in the first wiring layer, by a contact 403 formed in the contact layer. The wiring 316 is coupled to a wiring 332 formed in the third wiring layer and extending in the Y-axis direction through a via 413 formed in the first via layer and a via 423 formed in the second via layer. The wiring 332 is the data line 12.

In FIG. 15, as shown in L1, the gate of the MOSFET 205 formed in the polysilicon layer is coupled to a wiring 315, which is formed in the first wiring layer, by a contact 409. As shown in L1 to L4, the drain of the MOSFET 205 formed in the diffusion layer is coupled to a wiring 335, which is formed in the third wiring layer and extends in the Y-axis direction, by a contact 405 formed in the contact layer and vias 415 and 425 formed in the first via layer and second via layer, respectively.

The wiring 335 is not a component of the layout of the pixel circuit 20, and a large number of wirings 335 are arrayed in the Y-axis direction. Each wiring 335 is coupled to the pixel electrode 41 of the corresponding subpixel SP. In FIG. 15, two wirings 335 overlap the pixel circuits 20 in the Z-axis direction, and the drain of the MOSFET 205 overlaps the wiring 335 on the upper side and is coupled to the wiring 335. However, as will be described later, a pitch at which the pixel circuits 20 are arrayed in the Y-axis direction is slightly different from a pitch at which the wirings 335 are arrayed in the Y-axis direction, and thus the relative positions of each pixel circuit 20 and the wiring 335 coupled to the pixel circuit 20 is shifted slightly. For this reason, a position at which the drain of the MOSFET 205 is coupled to the wiring 335 is also shifted slightly.

In FIG. 15, as shown in L1, a wiring 311a formed in the first wiring layer is coupled to a wiring 301, which is formed in the polysilicon layer, by a contact 400 formed in the contact layer. In addition, as shown in L1 to L4, the wiring 311a is coupled to a wiring 322, which is formed in the second wiring layer, by vias 411a, 411b, 411c, 411d, and 411e formed in the first via layer. The wiring 322 is coupled to a wiring 331, which is formed in the third wiring layer and extends in the Y-axis direction, by vias 421a, 421b, 421c, 421d, and 421e formed in the second via layer, and is coupled to a wiring 333, which is formed in the third wiring layer and extends in the Y-axis direction, by vias 422a, 422b, 422c, 422d, and 422e formed in the second via layer. The wiring 331 is coupled to a wiring 341, which is formed in the fourth wiring layer, by vias 431a, 431b, 431c, 431d, and 431e formed in the third via layer. The wiring 333 is coupled to the wiring 341 by vias 432a, 432b, 432c, 432d, and 432e formed in the third via layer.

The m/2×4n pixel circuits 20 are disposed such that regions surrounded by dashed lines are adjacent to each other in the X-axis direction and the Y-axis direction. Thus, as shown in L1 and L2, the gates of the MSFETs 203, 204, 205 of the 4n pixel circuits 20 arrayed in the X-axis direction are coupled in common. Furthermore, the wirings 311a of the 4n pixel circuits 20 arrayed in the X-axis direction are coupled in common, thereby forming one wiring 311a. Furthermore, as shown in L1, in an arrangement region for two pixel circuits 20 adjacent to each other in the X-axis direction, a wiring 301 formed in the polysilicon layer is sandwiched between the gates of two MOSFETS 202, and thus gates of 4n MOSFETs 202 arrayed in the X-axis direction and 4n wirings 301 are disposed alternately. Furthermore, in a region where 4n pixel circuits 20 are arrayed in the X-axis direction, each of wirings 313, 314, and 315 extending in the X-axis direction is formed. Then, the scanning signal XGWR[i] and the control signals XGCMP[i] and XGEL[i] are supplied to the wirings 313, 314, and 315 in the i-th row, respectively.

In addition, as shown in L2, in a region where m/2×4n pixel circuits 20 are arrayed in the X-axis direction and Y-axis direction, the wiring 322 extending in the X-axis direction and Y-axis direction is formed. In addition, as shown in L3 and L4, in a region where m/2 pixel circuits 20 are arrayed in the Y-axis direction, each of the wirings 331, 332, 333, and 336 extending in the Y-axis direction is formed. In addition, as shown in L4, in an arrangement region for two pixel circuits 20 adjacent to each other in the Y-axis direction, a wiring 342 is coupled to the wiring 341, and in a region where m/2 pixel circuits 20 are arrayed in the Y-axis direction, one wiring 341 to which the wiring 342 is coupled and which extends in the Y-axis direction is formed. Then, the potential VEL is supplied to the wiring 341, and the potential VEL is supplied from the wiring 341 to the wirings 331, 333, 322, 311a, and 301. Furthermore, the potential VINI is supplied to the wiring 336, and the wiring 332 becomes the data line 12. In the third wiring layer, the wiring 332, which is the data line 12, is sandwiched between the wiring 331 and the wiring 333, and thus the wirings 331 and 333 to which a constant potential VEL is supplied function as shield wirings for the data line 12. Furthermore, the wiring 332, which is the data line 12, overlaps the wiring 341 in plan view, and thus the wiring 341 to which a constant potential VEL is supplied also functions as a shield wiring for the data line 12. These shield wirings reduce the influence of a change in the potential of the data line 12 on other adjacent data lines 12 and the influence of a change in the potential of the data transfer line 17 on the data line 12.

Since the wirings 311a and 311b forming the capacitive element 201 overlap the wiring 322 in plan view, the wiring 322 to which the constant potential VEL is supplied functions as a shield wiring for the capacitive element 201. In addition, since the gates of the 4n MOSFETs 202 arrayed in the X-axis direction and 4n wirings 301 are alternately disposed, the wiring 301 to which a constant potential VEL is supplied functions as a shield wiring for the gates of two MOSFETS 202 adjacent to each other in the X-axis direction. These shield wirings reduce the influence of a change in the potential of the data line 12 on the capacitive element 201 and the influence of a change in the potential of the capacitive element 201 on other adjacent capacitive elements 201.

In the present embodiment, as described above, m/2×4n pixel circuits 20 included in the display panel 2 are divided into q×n pixel circuit blocks BLK[1,1] to BLK[q, n], and each pixel circuit block BLK[k, j] includes 4×p light emitting elements 27, 4×p pixel circuits 20, four switching circuits 22, and four data lines 12 corresponding to 4×p subpixels SP.

On the other hand, in the display region 112 of the display panel 2, m×n pixels P are arranged in m rows and n columns, and thus n pixels P are arrayed at equal pitches in each row in the X-axis direction, and m pixels P are arrayed at equal pitches in each column in the Y-axis direction. One pixel P is configured with two light emitting elements 27 corresponding to a red or blue subpixel SP and a green subpixel SP.

The integer j is set as an odd number, and in the pixel circuit block BLK[k, j], four pixel circuits 20 coupled to the scanning line 11 in the i-th row correspond, in order from the left, to the red subpixel SP of the pixel P in the i-th row and the j-th column, the blue subpixel SP of the pixel P in the (i+1)-th row and the j-th column, the blue subpixel SP of the pixel P in the i-th row and the (j+1)-th column, and the red subpixel SP of the pixel P in the (i+1)-th row and the (j+1)-th column. Further, in the pixel circuit block BLK[k, j+1], four pixel circuits 20 coupled to the scanning line 11 in the i-th row correspond, in order from the left, to the green subpixel SP of the pixel P in the i-th row and the j-th column, the green subpixel SP of the pixel P in the (i+1)-th row and the j-th column, the green subpixel SP of the pixel P in the i-th row and the (j+1)-th column, and the green subpixel SP of the pixel P in the (i+1)-th row and the (j+1)-th column. That is, eight pixel circuits 20 configured with four pixel circuits 20 of the pixel circuit block BLK[k, j] and four pixel circuits 20 of the pixel circuit block BLK[k, j+1], which are coupled to the scanning line 11 in the i-th row, correspond to four pixels P.

Thus, the size of the arrangement region for 8×p pixel circuits 20 and eight switching circuits 22 included in the pixel circuit block BLK[k, j] or the pixel circuit block BLK[k, j+1] is made to match the size of the arrangement region for 2×p pixels P in the j-th column j and 2×p pixels P in the j+1-th column, thereby reducing the layout area of the display panel 2.

For example, when m=n=3960 and p=44, q=3096÷44+2=45. In this case, the arrangement region for 8×44 pixel circuits 20 and eight switching circuits 22 included in the pixel circuit block BLK[k, j] or the pixel circuit block BLK[k, j+1] is made to match the arrangement region for 2×44 pixels P in the j-th column and 2×44 pixels P in the j+1-th column. When the layout size of the pixel circuit 20 shown in FIG. 15 is 1.1 μm×8.6 μm, 44 pixel circuits 20 are arrayed in the Y-axis direction, and thus the length of the arrangement region for 8×44 pixel circuits 20 in the X-axis direction is 1.1 μm×8=8.8 μm, and the length in the Y-axis direction is 8.6 μm×44=378.4 μm. On the other hand, when a pitch at which the pixels P are arrayed in the Y-axis direction is 4.4 μm, the pixels P are arrayed in 88 rows in the Y-axis direction and 2 columns in the X-axis direction, and thus the length of the arrangement region for 2×88 pixels P in the X-axis direction is 4.4 μm×2=8.8 μm, and the length in the Y-axis direction is 4.4 μm×88=387.2 μm. Thus, the region of 8.8 μm×8.8 μm remaining after excluding the arrangement region for 8×44 pixel circuits 20 from the arrangement region for 2×88 pixels P becomes the arrangement region for eight switching circuits 22.

Thus, the length of the arrangement region for the pixel circuits 20 in the Y-axis direction is 8.6 μm, which is shorter than 8.8 μm which is a pitch of two pixels P. The wirings 335 are arrayed in the Y-axis direction at a pitch of two pixels P, that is, a pitch of 8.8 μm, and the relative positions of each pixel circuit 20 and the wiring 335 coupled to the pixel circuit 20 is shifted by 0.2 μm. Thus, the positions of the contact 405 and the vias 415 and 425 that couple the drain of the MOSFET 205 of the pixel circuit 20 to the wiring 335 are also shifted by 0.2 μm.

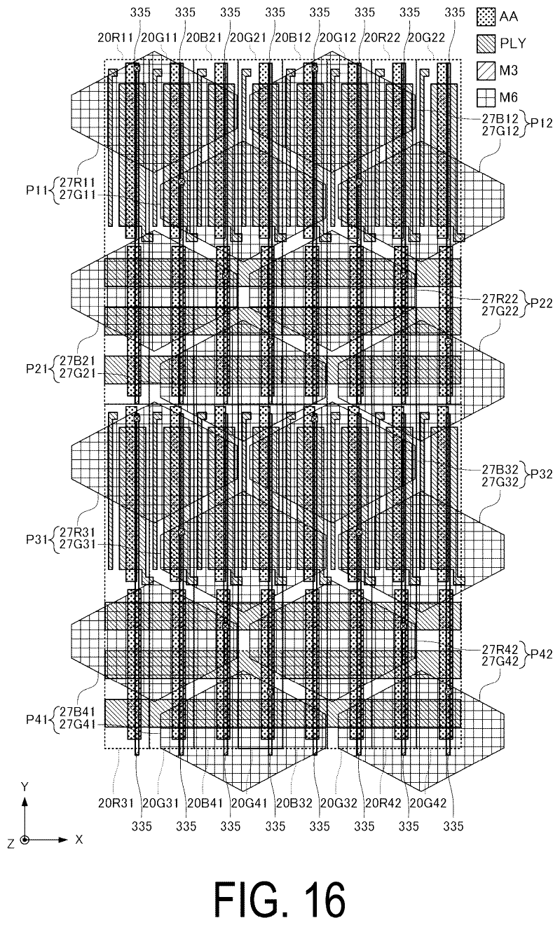

FIGS. 16 to 19 are diagrams showing a part of the layout of the display panel 2 where m=n=3960, p=44, and q=45. FIG. 16 is a plan view showing a configuration example of the layout of eight pixels P in the first to fourth rows and first and second columns, and 16 pixel circuits 20 coupled to the eight pixels P. FIG. 16 shows the layout of a diffusion layer (AA), a polysilicon layer (PLY), a third wiring layer (M3), and a sixth wiring layer (M6). Furthermore, for the third wiring layer (M3), only the layout of the wiring 335 is shown.

In FIG. 16, pixel electrodes 41 of 16 light emitting elements 27 are formed in the sixth wiring layer. A light emitting element 27R11 is a red subpixel SP of a pixel P11 in the first row and the first column, and a light emitting element 27G11 is a green subpixel SP of the pixel P11 in the first row and the first column. A light emitting element 27B21 is a blue subpixel SP of a pixel P21 in the second row and the first column, and a light emitting element 27G21 is a green subpixel SP of the pixel P21 in the second row and the first column. A light emitting element 27B12 is a blue subpixel SP of a pixel P12 in the first row and the second column, and a light emitting element 27G12 is a green subpixel SP of the pixel P12 in the first row and the second column. A light emitting element 27R22 is a red subpixel SP of a pixel P22 in the second row and the second column, and a light emitting element 27G22 is a green subpixel SP of the pixel P22 in the second row and the second column. A light emitting element 27R31 is a red subpixel SP of a pixel P31 in the third row and the first column, and a light emitting element 27G31 is a green subpixel SP of the pixel P31 in the third row and the first column. A light emitting element 27B41 is a blue subpixel SP of a pixel P41 in the fourth row and the first column, and a light emitting element 27G41 is a green subpixel SP of the pixel P41 in the fourth row and the first column. A light emitting element 27B32 is a blue subpixel SP of a pixel P32 in the third row and the second column, and a light emitting element 27G32 is a green subpixel SP of the pixel P32 in the third row and the second column. A light emitting element 27R42 is a red subpixel SP of a pixel P42 in the fourth row and the second column, and a light emitting element 27G42 is a green subpixel SP of the pixel P42 in the fourth row and the second column. In this manner, each of the plurality of light emitting elements 27 that are red subpixels SP and each of the plurality of light emitting elements 27 that are blue subpixels SP are arrayed alternately in the Y-axis direction. By disposing the plurality of light emitting elements 27 in this manner, a pixel P can be configured with two subpixels SP, red and green, or blue and green, rather than three subpixels SP, red, blue, and green. That is, since the number of light emitting elements 27 that configure one pixel P can be reduced, the display region 112 can be made smaller, or the number of pixels P in the display region 112 can be increased.

The pixel electrodes 41 of the light emitting elements 27R11, 27G11, 27B21, and 27G21 are coupled to the wirings 335 coupled to the drains of the MOSFETs 205 of the pixel circuits 20R11, 20G11, 20B21, and 20G21 through vias. The pixel electrodes 41 of the light emitting elements 27B12, 27G12, 27R22, and 27G22 are coupled to the wirings 335 coupled to the drains of the MOSFETs 205 of the pixel circuits 20B12, 20G12, 20R22, and 20G22 through vias.

The pixel electrodes 41 of the light emitting elements 27R31, 27G31, 27B41, and 27G41 are coupled to the wirings 335 coupled to the drains of the MOSFETs 205 of the pixel circuits 20R31, 20G31, 20B41, and 20G41 through vias. The pixel electrodes 41 of the light emitting elements 27B32, 27G32, 27R42, and 27G42 are coupled to the wirings 335 coupled to the drains of the MOSFETs 205 of the pixel circuits 20B32, 20G32, 20R42, and 20G42 through vias.

In this manner, the arrangement region for eight pixels P and the arrangement region for 16 pixel circuits 20 overlap each other in plan view.

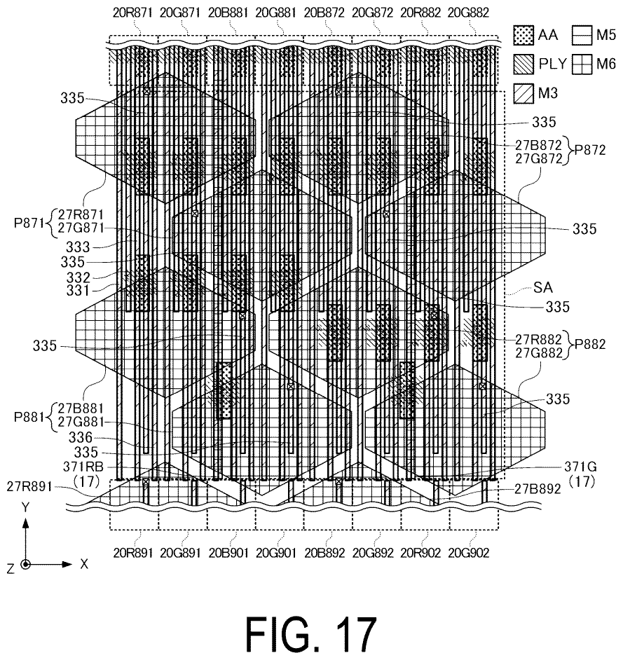

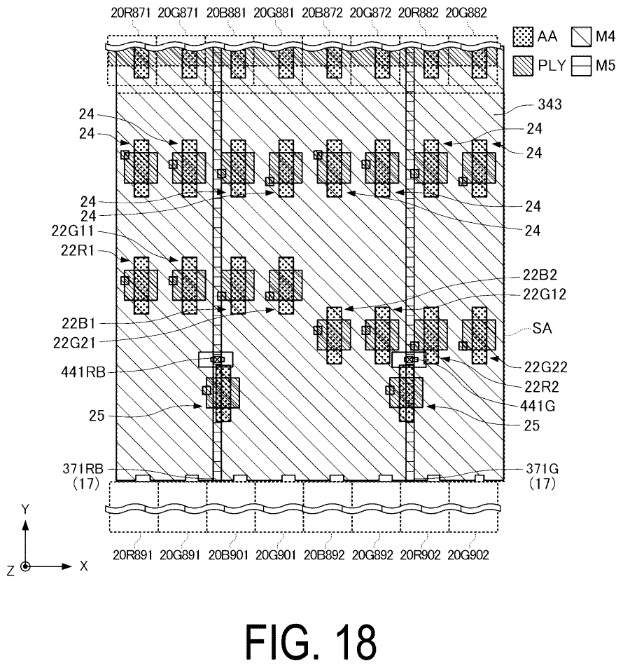

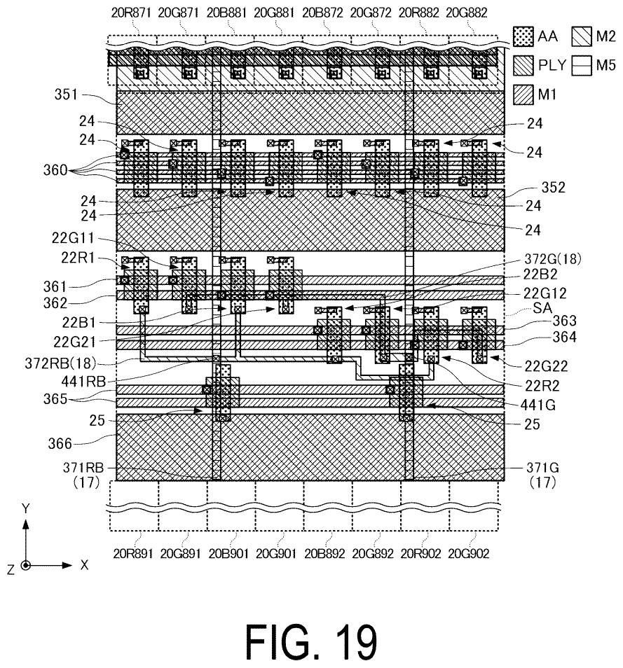

FIGS. 17, 18 and 19 are plan views showing a configuration example of the layout of a switching circuit arrangement region in which eight switching circuits 22, eight MOSFETs 24, and two MOSFETs 25 are disposed. FIG. 17 shows the layout of a diffusion layer (AA), a polysilicon layer (PLY), a third wiring layer (M3), a fifth wiring layer (M5), and a sixth wiring layer (M6). FIG. 18 shows the layout of a diffusion layer (AA), a polysilicon layer (PLY), a fourth wiring layer (M4), and a fifth wiring layer (M5). FIG. 19 shows the layout of a diffusion layer (AA), a polysilicon layer (PLY), a first wiring layer (M1), a second wiring layer (M2), and a fifth wiring layer (M5).

As shown in FIG. 17, pixel electrodes 41 of eight light emitting elements 27 are formed in the sixth wiring layer to overlap a switching circuit arrangement region SA in plan view.

A light emitting element 27R871 is a red subpixel SP of a pixel P871 in the 87th row and the first column, and a light emitting element 27G871 is a green subpixel SP of the pixel P871 in the 87th row and the first column. A light emitting element 27B881 is a blue subpixel SP of a pixel P881 in the 88th row and the first column, and a light emitting element 27G881 is a green subpixel SP of the pixel P881 in the 88th row and the first column. A light emitting element 27B872 is a blue subpixel SP of a pixel P872 in the 87th row and the second column, and a light emitting element 27G872 is a green subpixel SP of the pixel P872 in the 87th row and the second column. A light emitting element 27R882 is a red subpixel SP of a pixel P882 in the 88th row and the second column, and a light emitting element 27G882 is a green subpixel SP of the pixel P22 in the 88th row and the second column.

The pixel electrodes 41 of the light emitting elements 27R871, 27G871, 27B881, and 27G881 are coupled to the wirings 335 coupled to the drains of the MOSFETs 205 of pixel circuits 20R871, 20G871, 20B881, and 20G881 through vias. The pixel electrodes 41 of the light emitting elements 27B872, 27G872, 27R882, and 27G882 are coupled to the wirings 335 coupled to the drains of the MOSFETs 205 of the pixel circuits 20B872, 20G872, 20R882, and 20G882 through vias. The pixel circuits 20R871, 20G871, 20B881, 20G881, 20B872, 20G872, 20R882, and 20G882 are disposed adjacent to the upper side of the switching circuit arrangement region SA. Further, in FIG. 17, only parts of the pixel circuits 20R871, 20G871, 20B881, 20G881, 20B872, 20G872, 20R882, and 20G882 are shown.

A light emitting element 27R891 is a red subpixel SP of a pixel P891 in the 89th row and the second column, and is disposed adjacent to the light emitting element 27B881 in the Y-axis direction. A light emitting element 27B892 is a blue subpixel SP of a pixel P892 in the 89th row and the first column, and is disposed adjacent to the light emitting element 27R882 in the Y-axis direction. The light emitting element 27R891 is coupled to a pixel circuit 20R891, and the light emitting element 27B892 is coupled to a pixel circuit 20B892.

As shown in FIG. 19, in plan view, in a third region extending in the X-axis direction between a first region in which 44 pixel circuits 20R11, 20R31, . . . , and 20R871 and 44 pixel circuits 20B21, 20B41, . . . , and 20B881 are disposed and a second region in which the pixel circuit 20R891 is disposed, a wiring 371RB, which is the data transfer line 17, and a wiring 372RB, which is the data transfer line 18, are coupled. Similarly, a wiring 371G, which is the data transfer line 17, and a wiring 372G, which is the data transfer line 18, are coupled in the third region. The third region is a part of the switching circuit arrangement region SA, and switching circuits 22R1, 22G11, 22B1, 22G21, 22B2, 22G12, 22R2, and 22G22 are also disposed in the third region. In this manner, in the third region which is a part of the switching circuit arrangement region SA, each of the two data transfer lines 17 and each of the two data transfer lines 18 are coupled to each other, and eight switching circuits 22 are disposed, thereby curbing an increase in the size of a layout area.

As shown in FIGS. 17, 18 and 19, eight MOSFETs 24 arrayed in the X-axis direction are formed in the diffusion layer and the polysilicon layer. The drains of the eight MOSFETs 24 extend in the Y-axis direction and are coupled to eight data lines 12 coupled to the pixel circuits 20R871, 20G871, 20B881, 20G881, 20B872, 20G872, 20R882 and 20G882, respectively, through wirings, contacts and vias. The gates of the eight MOSFETs 24 are coupled to any one of four wirings 360, which are formed in the first wiring layer and extending in the X-axis direction, through contacts. The control signal XGINI[k] is supplied to the four wirings 360.

In addition, four switching circuits 22R1, 22G11, 22B1, and 22G21, which are arrayed in the X-axis direction in order from the left, are formed in the diffusion layer and the polysilicon layer. The drains of the switching circuits 22R1, 22G11, 22B1, and 22G21 are coupled to the four data lines 12, which are coupled to the pixel circuits 20R871, 20G871, 20B881, and 20G881, respectively, through contacts and vias.

In addition, four switching circuits 22B2, 22G12, 22R2, and 22G22, which are arrayed in the X-axis direction in order from the left, are formed in the diffusion layer and the polysilicon layer. The drains of the switching circuits 22B2, 22G12, 22R2, and 22G22 are coupled to the four data lines 12, which are coupled to the pixel circuits 20B872, 20G872, 20R882, and 20G882, respectively, through contacts and vias.

The sources of the switching circuits 22R1, 22B1, 22B2, and 22R2 are coupled to the wiring 372RB, which extends in the X-axis direction intersecting the Y-axis direction, through contacts and vias. The sources of the switching circuits 22G11, 22G21, 22G12, and 22G22 are coupled to the wiring 372G, which extends in the X-axis direction, through contacts and vias. The wiring 372RB is coupled to the wiring 371RB, which extends in the Y-axis direction, through a via 441RB. The wiring 372G is coupled to the wiring 371G, which extends in the Y-axis direction, through a via 441G. The wiring 371RB is the data transfer line 17 in the first column, and a data potential VDATA[1] is supplied to the wiring 371RB. The wiring 372RB is the data transfer line 18 branching off from the data transfer line 17. The wiring 371G is the data transfer line 17 in the second column, and a data potential VDATA[2] is supplied to the wiring 371G. The wiring 372G is the data transfer line 18 branching off from the data transfer line 17.

In this manner, in plan view, the data transfer line 17 and the data transfer line 18 are coupled in a switching circuit arrangement region SA between a first region in which a plurality of pixel circuits 20 included in pixel circuit blocks BLK[1,1] and BLK[1,2] are disposed and a second region in which a plurality of pixel circuits 20 included in pixel circuit blocks BLK[2,1] and BLK[2,2] are disposed.

The wirings 371RB and 371G, which are data transfer lines 17, are formed in the fifth wiring layer. As described with reference to FIG. 15, the wiring 341, which is formed in the fourth wiring layer and to which a constant potential VEL is supplied, overlaps the data line 12, which is the wiring 332 formed in the third wiring layer, and thus the wiring 341 functions as a wiring that shields the data line 12 from the data transfer line 17. In addition, as described with reference to FIG. 15, the wiring 322, which is formed in the second wiring layer and to which a constant potential VEL is supplied, overlaps the wirings 311a and 311b formed in the first wiring layer, and thus the wiring 322 functions as a wiring that shields the capacitive element 201 formed by the wirings 311a and 311b from the data transfer line 17.

As shown in FIGS. 16 and 17, in plan view, the wirings 371RB and 371G, which are data transfer lines 17, overlap at least one of the plurality of light emitting elements 27 which are red subpixels SP, overlap at least one of the plurality of light emitting elements 27 which are blue subpixels SP, and overlap at least one of the plurality of light emitting elements 27 which are green subpixels SP. Furthermore, as shown in FIGS. 17, 18 and 19, in plan view, the data transfer line 18 overlaps at least one of the plurality of light emitting elements 27 which are red subpixels SP and the plurality of light emitting elements 27 which are blue subpixel SP. Thus, an increase in the size of a layout area due to the data transfer lines 17 and 18 is curbed.

The data potential generating circuit 23 that supplies the data potential VDATA[1] to the wiring 371RB is disposed in a region on the lower side of the arrangement region for the two pixels P in the first and second columns of the 3096th row. In addition, the data potential generating circuit 23 that supplies the data potential VDATA[2] to the wiring 371G is disposed in a region on the upper side of the arrangement region for the two pixels P in the first and second columns of the first row.

As shown in FIG. 19, the gates of the switching circuits 22R1 and 22G11 are coupled to a wiring 361, which is formed in the first wiring layer and extends in the X-axis direction, through contacts. The control signal XSEL1[k] is supplied to the wiring 361. The gates of the switching circuits 22B1 and 22G21 are coupled to a wiring 362, which is formed in the first wiring layer and extends in the X-axis direction, through contacts. The control signal XSEL2[k] is supplied to the wiring 362. The gates of the switching circuits 22B2 and 22G12 are coupled to a wiring 363, which is formed in the first wiring layer and extends in the X-axis direction, through contacts. The control signal XSEL3[k] is supplied to the wiring 363. The gates of the switching circuits 22R2 and 22G22 are coupled to a wiring 364, which is formed in the first wiring layer and extends in the X-axis direction, through contacts. The control signal XSEL4[k] is supplied to the wiring 364.

In addition, two MOSFETs 25 are formed in the diffusion layer and the polysilicon layer. The drain of the MOSFET 25 on the left side is coupled to the wiring 371RB, which is the data transfer line 17, through contacts and vias, and the drain of the MOSFET 25 on the right side is coupled to the wiring 371G, which is the data transfer line 17, through contacts and vias. The sources of the two MOSFETs 25 are coupled to a wiring 366, which is formed in the first wiring layer and the second wiring layer and extends in the X-axis direction, through contacts and vias. The potential VRES is supplied to the wiring 366. The gates of the two MOSFETs 25 are coupled to two wirings 365, which are formed in the first wiring layer and extend in the X-axis direction, through contacts. The control signal XRES is supplied to the two wirings 365.

In addition, as shown in FIG. 18, a wiring 343 is formed in the fourth wiring layer over the entire region of the switching circuit arrangement region SA. The wiring 343 is coupled to each wiring 341 extending in the Y-axis direction. As shown in FIG. 19, wirings 351 and 352 extending in the X-axis direction are formed in the second wiring layer in the switching circuit arrangement region SA. The wiring 351 is coupled to the wirings 331 and 333, which are formed in the third wiring layer and extend in the Y-axis direction, and the wirings 341, which are formed in the fourth wiring layer and extending in the Y-axis direction, through vias. The potential VEL is supplied to the wiring 351. The wiring 352 is coupled to the wirings 336, which are formed in the third wiring layer and extend in the Y-axis direction, through vias. The potential VINI is supplied to the wiring 351. The wiring 352 becomes one long wiring extending in the X-axis direction in n/2 switching circuit arrangement regions SA arrayed in the X-axis direction. In this manner, since the wirings 351 and 336 to which the potential VINI is supplied are formed in the X-axis direction and the Y-axis direction, the potential VINI supplied to each pixel circuit 20 is stabilized, and unevenness in an image displayed in the display region 112 is improved.

In the present embodiment, the light emitting elements 27R11, 27R31, . . . , and 27R871 are an example of “a plurality of first light emitting elements”, and the pixel circuits 20R11, 20R31, . . . , and 20R871 are an example of “a plurality of first pixel circuits”. Furthermore, the light emitting elements 27B21, 27B41, . . . , and 27B881 are an example of “a plurality of second light emitting elements”, and the pixel circuits 20B21, 20B41, . . . , and 20B881 are an example of “a plurality of second pixel circuits”. Furthermore, the light emitting element 27R891 is an example of a “third light emitting element”, and the pixel circuit 20R891 is an example of a “third pixel circuit”. Furthermore, the wiring 371RB is an example of a “first data transfer line”, and the wiring 372RB is an example of a “second data transfer line”. Furthermore, the switching circuit 22R1 is an example of a “first switching circuit”, and the switching circuit 22B1 is an example of a “second switching circuit”. The wiring 332, which is the data line 12 coupled to the switching circuit 22R1, is an example of a “first data line”, and the wiring 332, which is the data line 12 coupled to the switching circuit 22B1, is an example of a “second data line”. Furthermore, the Y-axis direction is an example of a “first direction”, and the X-axis direction is an example of a “second direction”.

### 1-7. Operations and Effects

As described above, in the display device 1 according to the present embodiment, m/2×4 pixel circuits 20 to which the data potential VDATA[j] is supplied are not coupled in common to the data transfer line 17, but are divided into q pixel circuit blocks BLK[1,j] to BLK[q, j], and p×4 pixel circuits 20 included in the pixel circuit blocks BLK[k, j] are coupled to the data transfer line 18 branching off from the data transfer line 17 via four switching circuits 22. That is, p pixel circuits 20 are coupled to four data lines 12 branching off from the data transfer line 18 via four switching circuits 22. For this reason, when data is written to each pixel circuit 20, only q×4 switching circuits 22 and p pixel circuits 20 are coupled to the data transfer lines 17, and thus a load on each data transfer line 17 is reduced. Thus, according to the display device 1 of the present embodiment, each data transfer line 17 can be driven at high speed, and thus, for example, a high-definition image can be displayed.

For example, as described above, when m=n=3960, p=44, and q=45, 7920 pixel circuits 20 are divided into 45 pixel circuit blocks BLK[1, j] to BLK[45, j], each of which has 44 pixel circuits, and data is written to the 7920 pixel circuits 20 via one data transfer line 17. Since 4×45=180 switching circuits 22 are coupled to one data transfer line 17, these 180 switching circuits 22 become a load on the data transfer line 17 at all times. Furthermore, when data is written to each pixel circuit 20, only one of the 180 switching circuits 22 is turned on, and thus 44 pixel circuits 20 are coupled to one data transfer line 17 via the data transfer line 18. Thus, during the write period c, the 180 switching circuits 22 and the 44 pixel circuits 20 become a load on the data transfer line 17. Thus, compared to a configuration of the related art in which 3,960 pixel circuits 20 are coupled to one data transfer line 17, a load on the data transfer line 17 is reduced to approximately 1/18. When a time for one frame is approximately 16 ms, writing to 7920 pixels P for two columns is performed in the horizontal scanning period 1H, and thus the horizontal scanning period 1H is approximately 8 μs. By reducing a load on the data transfer line 17, the first write period c1, the second write period c2, the third write period c3, and the fourth write period c4 can each be realized in 1 μs in the horizontal scanning period 1H, and when 6 μs is secured as a time for the write period c, 2 μs can be secured as times for the initialization period a and the compensation period b. hus, according to the display device 1 of the present embodiment, it is possible to sufficiently display 3960×3960 pixels P during a period of one frame, and a high-definition image can be displayed on the display panel 2.

Further, in the display device 1 according to the present embodiment, the integer j is set as an odd number, and the arrangement region for p×8 pixel circuits 20, which are included in the pixel circuit blocks BLK[k, j] or BLK[k, j+1], overlaps the arrangement region for p×4 pixels P formed by p×8 light emitting elements 27 coupled to the p×8 pixel circuits 20 in plan view. In particular, the length of the p×4 pixel circuits 20 in the Y-axis direction is made smaller than twice the pitch at which the p×4 pixels P are arrayed in the Y-axis direction, and thus eight switching circuits 22 can be disposed in a region excluding the arrangement region for the p×8 pixel circuits 20 from the arrangement region for the p×4 pixels P in plan view. Thus, according to the display device 1 of the present embodiment, an increase in the size of a layout area of the display panel 2 due to the switching circuits 22 is curbed.

### 2. Electronic Apparatus

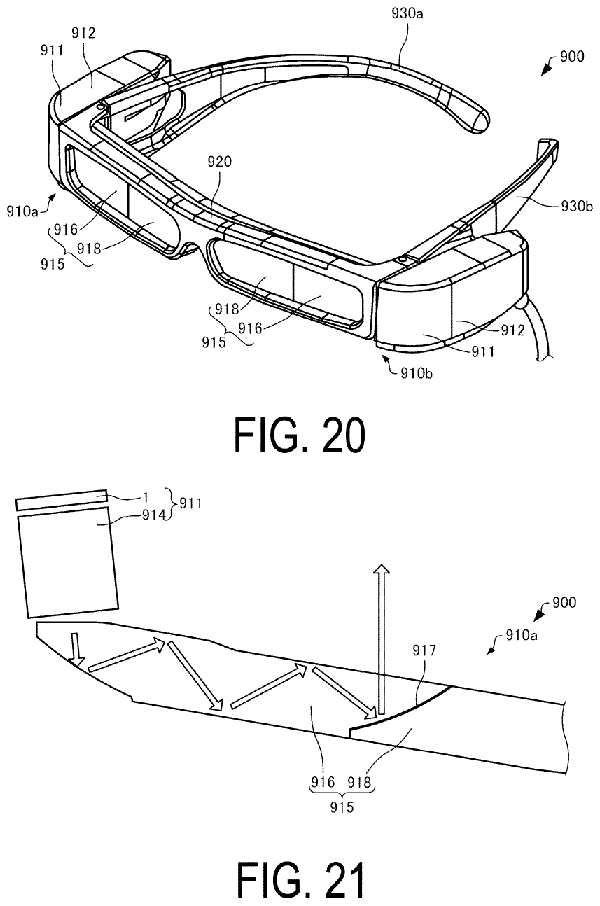

A head mounted display will be described as an example of an electronic apparatus of the present embodiment. FIG. 20 is a schematic perspective view showing a head mounted display 900, which is an example of an electronic apparatus of the present embodiment.

As shown in FIG. 20, the head mounted display 900 is a head mounted display that has an outer appearance of an eyewear. The head mounted display 900 is mounted on the head of a viewer. The viewer is a user who uses the head mounted display 900. The head mounted display 900 allows the viewer to visually recognize video light of a virtual image and to visually recognize an external image in a see-through manner.

The head mounted display 900 includes, for example, a first display unit 910a, a second display unit 910b, a frame 920, a first temple 930a, and a second temple 930b.

The first display unit 910a and the second display unit 910b display images. Specifically, the first display unit 910a displays a virtual image for the right eye of the viewer. The second display unit 910b displays a virtual image for the left eye of the viewer. The display units 910a and 910b include, for example, an image forming device 911 and a light guiding device 915.

The image forming device 911 generates image light. The image forming device 911 includes, for example, an optical system such as a light source and a projection device, and an external member 912. The external member 912 accommodates the light source and the projection device.

The light guiding device 915 covers the front of the eyes of the viewer. The light guiding device 915 guides the video light formed by the image forming device 911 and allows the viewer to visually recognize external light and the video light in an overlapping manner.

The frame 920 supports the first display unit 910a and the second display unit 910b. For example, the frame 920 surrounds the display units 910a and 910b. In the example shown in the drawing, the image forming device 911 of the first display unit 910a is attached to one end of the frame 920. The image forming device 911 of the second display unit 910b is attached to the other end of the frame 920.

The first temple 930a and the second temple 930b extend from the frame 920. In the example shown in the drawing, the first temple 930a extends from one end of the frame 920. The second temple 930b extends from the other end of the frame 920.

The first temple 930a and the second temple 930b are put on the ears of the viewer when the head mounted display 900 is worn by the viewer. The head of the viewer is positioned between the temples 930a and 930b.

FIG. 21 is a schematic diagram showing the image forming device 911 and the light guiding device 915 of the first display unit 910a of the head mounted display 900. The first display unit 910a and the second display unit 910b have basically the same configuration. Thus, the following description of the first display unit 910a can be applied to the second display unit 910b.

As shown in FIG. 21, for example, the image forming device 911 includes the display device 1 as a light source and a projection device 914 for image formation.

The projection device 914 projects, toward the light guiding device 915, the video light emitted from the display device 1. The projection device 914 is, for example, a projection lens. As the lens configuring the projection device 914, a lens having an axially symmetric surface as a lens surface may be used.

The light guiding device 915 is accurately positioned with respect to the projection device 914, for example, by being screwed to a lens barrel of the projection device 914. The light guiding device 915 includes, for example, a video light guiding member 916 that guides the video light and a see-through member 918 for see-through view.

The video light emitted from the projection device 914 is incident on the video light guiding member 916. The video light guiding member 916 is a prism that guides the video light toward the eyes of the viewer. The video light incident on the video light guiding member 916 is repeatedly reflected on the inner surface of the video light guiding member 916, and is then reflected by a reflective layer 917 to be emitted from the video light guiding member 916. The video light emitted from the video light guiding member 916 reaches the eyes of the viewer. The reflective layer 917 is configured with, for example, a metal or a dielectric multilayer film. The reflective layer 917 may be a half mirror.

The see-through member 918 is adjacent to the video light guiding member 916. The see-through member 918 is fixed to the video light guiding member 916. The outer surface of the see-through member 918 is continuous with, for example, the outer surface of the video light guiding member 916. The viewer sees external light through the see-through member 918. The video light guiding member 916 also has a function of making the viewer see external light therethrough, in addition to the function of guiding video light. The head mounted display 900 may be configured not to allow the viewer to see external light therethrough.

According to the electronic apparatus of the present embodiment, since the electronic apparatus includes the display device 1 capable of driving the data lines 12 at high speed, for example, it is possible to cause the display device 1 to display a high-definition image.

The electronic apparatus including the display device 1 is not limited to a head mounted display, and may be, for example, an EVF, a projector, a wearable display such as a smart watch, or an in-vehicle head-up display. EVF is an abbreviation for Electronic View Finder.

The present disclosure is not limited to the present embodiment, and various modifications can be made within the scope of the present disclosure.

For example, in each embodiment described above, the data potential generating circuit 23 includes the capacitive DAC, but may have other configurations. For example, the j-th data potential generating circuit 23 may include a D/A conversion circuit and an amplifier circuit and acquire image data VIDX at a timing designated by the control circuit 3 and perform D/A conversion, and the amplifier circuit may amplify the potential after the D/A conversion and output a data potential VDATA[j].

The above-described embodiments and modification examples are merely examples and are not intended to be limiting. For example, the embodiments and modification examples may be combined as appropriate.

The present disclosure includes configurations that are substantially the same as the configurations described in the embodiment, for example, configurations with the same functions, methods and results, or with the same advantages and effects. In addition, the present disclosure includes configurations obtained by replacing non-essential portions of the configurations described in the embodiment. In addition, the present disclosure also includes configurations that achieve the same effects as the configurations described in the embodiment or configurations that can achieve the same purposes. Further, the present disclosure includes configurations obtained by adding known techniques to the configurations described in the embodiment.

The following contents are derived from the embodiment and the modification examples described above.

One aspect of the present disclosure provides a display device including:
a plurality of first light emitting elements;
a plurality of second light emitting elements;
a first data transfer line extending in a first direction;
a second data transfer line coupled to the first data transfer line and extending in a second direction intersecting the first direction;
a first data line extending in the first direction;
a second data line extending in the first direction;
a plurality of first pixel circuits coupled to the first data line and coupled respectively to the plurality of first light emitting elements;
a plurality of second pixel circuits coupled to the second data line and coupled respectively to the plurality of second light emitting elements;
a first switching circuit controlling electrical coupling between the first data line and the second data transfer line; and
a second switching circuit controlling electrical coupling between the second data line and the second data transfer line, wherein
the first data line is supplied, from the second data transfer line via the first switching circuit, with a signal for causing each of the plurality of first light emitting elements to emit light, and
the second data line is supplied, from the second data transfer line via the second switching circuit, with a signal for causing each of the plurality of second light emitting elements to emit light.

In the display device, the plurality of first pixel circuits and the plurality of second pixel circuits are not coupled in common to the data transfer line, but the plurality of first pixel circuits are coupled to the first data line branching off from the second data transfer line coupled to the data transfer line via the first switching circuit, and the plurality of second pixel circuits are coupled to the second data line branching off from the second data transfer line via the second switching circuit. When writing to each of the plurality of first pixel circuits is performed, the first switching circuit is turned on and the plurality of first pixel circuits are coupled to the first data transfer line, but the second switching circuit is turned off and the plurality of second pixel circuits are not coupled to the first data transfer line. For this reason, the plurality of first pixel circuits, the first switching circuit, and the second switching circuit become a load on the first data transfer line, but the plurality of second pixel circuits do not become a load on the first data transfer line. In contrast, when writing to each of the plurality of second pixel circuits is performed, the second switching circuit is turned on and the plurality of second pixel circuits are coupled to the first data transfer line, but the first switching circuit is turned off and the plurality of first pixel circuits are not coupled to the first data transfer line. For this reason, the plurality of second pixel circuits, the first switching circuit, and the second switching circuit become a load on the first data transfer line, but the plurality of first pixel circuits do not become a load on the first data transfer line. Thus, according to the display device, a load on the first data transfer line is reduced, and the first data transfer line can be driven at high speed, making it possible to display, for example, high-definition images.

In one aspect of the display device, each of the plurality of first light emitting elements and each of the plurality of second light emitting elements may be arrayed alternately in the first direction.

According to the display device, by making the color of a subpixel corresponding to the first light emitting element different from the color of a subpixel corresponding to the second light emitting element, the number of light emitting elements configuring one pixel can be reduced, thereby making it possible to reduce a display region for an image or increase the number of pixels in the display region.

One aspect of the present disclosure provides the display device further including:
a third light emitting element disposed adjacent to the second light emitting element in the first direction; and
a third pixel circuit coupled to the third light emitting element,
wherein, in plan view, the first data transfer line and the second data transfer line may be coupled to each other in a third region extending in the second direction between a first region in which the plurality of first pixel circuits and the plurality of second pixel circuits are disposed and a second region in which the third pixel circuit is disposed.

According to the display device, the third region extending in the second direction, in which the first data transfer line and the second data transfer line are coupled to each other, is provided between the first region in which the plurality of first pixel circuits and the plurality of second pixel circuits are disposed and a second region in which the third pixel circuit is disposed, in accordance with a pitch at which the plurality of first light emitting elements, the plurality of second light emitting elements, and the third light emitting elements are arrayed in the first direction, thereby curbing an increase in the size of a layout area due to the coupling between the first data transfer line and the second data transfer line.

In one aspect of the display device, the first switching circuit and the second switching circuit may be disposed in the third region.

According to the display device, the third region extending in the second direction, in which the first switching circuit and the second switching circuit are disposed, is provided between the first region in which the plurality of first pixel circuits and the plurality of second pixel circuits are disposed and the second region in which the third pixel circuit is disposed, in accordance with a pitch at which the plurality of first light emitting elements, the plurality of second light emitting elements, and the third light emitting elements are arrayed in the first direction, thereby curbing an increase in the size of a layout area due to the first switching circuit and the second switching circuit.

In one aspect of the display device, in plan view, the first data transfer line may overlap at least one of the plurality of first light emitting elements.

In the display device, the first data transfer line overlaps at least one of the plurality of first light emitting elements in plan view, and thus an increase in the size of a layout area due to the first data transfer line is curbed.

In one aspect of the display device, in plan view, the second data transfer line may overlap at least one of the plurality of first light emitting elements and the plurality of second light emitting elements.

In the display device, the second data transfer line overlaps at least one of the plurality of first light emitting elements and the plurality of second light emitting elements in plan view, and thus an increase in the size of a layout area due to the second data transfer line is curbed.

One aspect of an electronic apparatus includes the aspect of the display device.

According to the electronic apparatus, since the electronic apparatus includes a display device capable of driving data lines at high speed, it is possible to cause the display device to display, for example, high-definition images.

What is claimed is:

1. A display device comprising:
a plurality of first light emitting elements;
a plurality of second light emitting elements;
a first data transfer line extending in a first direction;
a second data transfer line coupled to the first data transfer line and extending in a second direction intersecting the first direction;
a first data line extending in the first direction;
a second data line extending in the first direction;
a plurality of first pixel circuits coupled to the first data line and coupled respectively to the plurality of first light emitting elements;
a plurality of second pixel circuits coupled to the second data line and coupled respectively to the plurality of second light emitting elements;
a first switching circuit controlling electrical coupling between the first data line and the second data transfer line; and
a second switching circuit controlling electrical coupling between the second data line and the second data transfer line, wherein
the first data line is supplied, from the second data transfer line via the first switching circuit, with a signal for causing each of the plurality of first light emitting elements to emit light, and
the second data line is supplied, from the second data transfer line via the second switching circuit, with a signal for causing each of the plurality of second light emitting elements to emit light.

2. The display device according to claim 1, wherein each of the plurality of first light emitting elements and each of the plurality of second light emitting elements are arrayed alternately in the first direction.

3. The display device according to claim 1, further comprising:
a third light emitting element disposed adjacent to the second light emitting element in the first direction; and
a third pixel circuit coupled to the third light emitting element,
wherein
in plan view, the first data transfer line and the second data transfer line are coupled to each other in a third region extending in the second direction between a first region in which the plurality of first pixel circuits and the plurality of second pixel circuits are disposed and a second region in which the third pixel circuit is disposed.

4. The display device according to claim 3, wherein the first switching circuit and the second switching circuit are disposed in the third region.

5. The display device according to claim 1, wherein, in plan view, the first data transfer line overlaps at least one of the plurality of first light emitting elements.

6. The display device according to claim 1, wherein, in plan view, the second data transfer line overlaps at least one of the plurality of first light emitting elements and the plurality of second light emitting elements.

7. An electronic apparatus comprising the display device according to claim 1.
